(19) United States
(12) Patent Application Publication
(10) Pub. No.: US 2026/0353384 A1
(43) Pub. Date: Nov. 5, 2026

(54) ROBUST CODEBOOK FOR FULLY COHERENT UE WITH EIGHT ANTENNA PORTS

(71) Applicant: Lenovo (Beijing) Limited, Beijing (CN)

(72) Inventors: Bingchao Liu, Beijing (CN); Lingling Xiao, Beijing (CN)

(73) Assignee: Lenovo (Beijing) Limited, Beijing (CN)

(21) Appl. No.: 19/110,465

(22) PCT Filed: Nov. 6, 2022
(86) PCT No.: PCT/CN2022/130166

§ 371 Date: Mar. 11, 2025

(51) Int. Cl. H04W 72/1268; H04B 7/0413; H04W 72/232

(52) U.S. Cl. CPC H04W 72/1268; H04B 7/0413; H04W 72/232

(57) ABSTRACT

Methods and apparatuses for 8Tx PUSCH and the corresponding TPMI indication are disclosed. In one embodiment, a UE comprises a transceiver; and a processor coupled to the transceiver, wherein the processor is configured to receive, via the transceiver, a DCI scheduling PUSCH transmission with 8 antenna ports, wherein the DCI includes a TPMI field indicating one or two 4Tx precoding matrices and a co-phasing coefficient; and determine a 8Tx precoding matrix for the scheduled PUSCH transmission according to the TPMI field.

### FIELD

The subject matter disclosed herein generally relates to wireless communications, and more particularly relates to methods and apparatuses for robust codebook for fully coherent UE with eight antenna ports.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Physical Uplink Shared Channel (PUSCH), codebook (CB), non-codebook (nCB), Transmit Precoding Matrix Indicator (TPMI), Sounding Reference Signal (SRS), Bandwidth part (BWP), Channel State Information Reference Signal (CSI-RS), Downlink Control Information (DCI), Discrete Fourier Transform (DFT).

PUSCH transmission with 8 antenna ports (8Tx PUSCH) shall be supported in NR Release 18 for advanced UE equipped with 8 antennas with one or multiple layers.

This disclosure targets codebooks for 8Tx PUSCH and the corresponding TPMI indication.

### BRIEF SUMMARY

Methods and apparatuses for 8Tx PUSCH and the corresponding TPMI indication are disclosed.

In one embodiment, a UE comprises a transceiver; and a processor coupled to the transceiver, wherein the processor is configured to receive, via the transceiver, a DCI scheduling PUSCH transmission with 8 antenna ports, wherein the DCI includes a TPMI field indicating one or two 4Tx precoding matrices and a co-phasing coefficient; and determine a 8Tx precoding matrix for the scheduled PUSCH transmission according to the TPMI field.

In some embodiment, if the scheduled PUSCH transmission is rank 1 PUSCH transmission, the co-phasing coefficient is indicated as 1,j, −1 or j, and if the scheduled PUSCH transmission is rank 2, rank 3, rank 4, rank 5, rank 6, rank 7 and rank 8 PUSCH transmission, the co-phasing coefficient is indicated as 1 or j.

In some embodiment, if the scheduled PUSCH transmission is rank 1 PUSCH transmission, the one 4Tx precoding matrix is a rank 1 4Tx precoding matrix; if the scheduled PUSCH transmission is rank 2 PUSCH transmission, the one 4Tx precoding matrix is a rank 2 4Tx precoding matrix; if the scheduled PUSCH transmission is rank 3 PUSCH transmission, the one 4Tx precoding matrix is a rank 3 4Tx precoding matrix; if the scheduled PUSCH transmission is rank 4 PUSCH transmission, the one 4Tx precoding matrix is a rank 4 4Tx precoding matrix; if the scheduled PUSCH transmission is rank 5 PUSCH transmission, the one 4Tx precoding matrix is a rank 3 4Tx precoding matrix, or the two 4Tx precoding matrices are a rank 2 4Tx precoding matrix and a rank 3 4Tx precoding matrix; if the scheduled PUSCH transmission is rank 6 PUSCH transmission, the one 4Tx precoding matrix is a rank 3 4Tx precoding matrix, or the two 4Tx precoding matrices are two rank 3 4Tx precoding matrices; if the scheduled PUSCH transmission is rank 7 PUSCH transmission, the one 4Tx precoding matrix is a rank 4 4Tx precoding matrix, or the two 4Tx precoding matrices are a rank 3 4Tx precoding matrix and a rank 4 4Tx precoding matrix; and if the scheduled PUSCH transmission is rank 8 PUSCH transmission, the one 4Tx precoding matrix is a rank 4 4Tx precoding matrix, or the two 4Tx precoding matrices are two rank 4 4Tx precoding matrices.

In some embodiment, if the maximum number of PUSCH layers of the scheduled PUSCH transmission is less than or equal to 4, the length of the part for indicating the one 4Tx precoding matrix is 4 bits for fully coherent only transmission, and is 5 bits for fully and partial and non-coherent transmission, and if the maximum number of PUSCH layers of the scheduled PUSCH transmission is larger than 4, the length of the part for indicating the one 4Tx precoding matrix is 2 bits or 4 bits for fully coherent only transmission and is 3 bits for fully and partial and non-coherent transmission, or the length of the part for indicating the two 4Tx precoding matrices is 3+2 bits or 4+4 bits for fully coherent only transmission and is 5+3 bits for fully and partial and non-coherent transmission.

In some embodiment, the processor is further configured to report, via the transceiver, a maxRank=8.

In some embodiment, the 8Tx precoding matrix for each rank is:
rank 1 8Tx precoding matrix:

$${W}_{8 T x , 1} = \frac{1}{\sqrt{2 MN}} \times [ \begin{matrix}{b}_{0} \\ {φ}_{l} {b}_{0}\end{matrix} ] ;$$

rank 2 8Tx precoding matrix:

$${W}_{8 T x , 2} = \frac{1}{\sqrt{4 MN}} \times [ \begin{matrix}{b}_{0} & {b}_{1} \\ {φ}_{l} {b}_{0} & - {φ}_{l} {b}_{1}\end{matrix} ] ;$$

rank 3 8Tx precoding matrix:

$${W}_{8 T x , 3} = \frac{1}{\sqrt{6 MN}} \times [ \begin{matrix}{b}_{0} & {b}_{1} & {b}_{2} \\ {φ}_{l} {b}_{0} & {φ}_{l} {b}_{1} & - {φ}_{l} {b}_{2}\end{matrix} ] ;$$

rank 4 8Tx precoding matrix:

$${W}_{8 T x , 4} = \frac{1}{\sqrt{8 MN}} \times [ \begin{matrix}{b}_{0} & {b}_{1} & {b}_{2} & {b}_{3} \\ {φ}_{l} {b}_{0} & {φ}_{l} {b}_{1} & - {φ}_{l} {b}_{2} & - {φ}_{l} {b}_{3}\end{matrix} ] ;$$

rank 5 8Tx precoding

$${W}_{8 T x , 5} = \frac{1}{\sqrt{10 M N}} \times [ \begin{matrix}{b}_{0 , 0} & {b}_{0 , 1} & {b}_{1 , 0} & {b}_{1 , 1} & {b}_{1 , 2} \\ {φ}_{l} {b}_{0 , 0} & - {φ}_{l} {b}_{0 , 1} & {b}_{1 , 0} & - {b}_{1 , 1} & {b}_{1 , 2}\end{matrix} ] or$$

$${W}_{8 T x , 5} = \frac{1}{\sqrt{10 M N}} \times [ \begin{matrix}{b}_{0} & {b}_{0} & {b}_{1} & {b}_{1} & {b}_{2} \\ {φ}_{l} {b}_{0} & - {φ}_{l} {b}_{0} & {b}_{1} & - {b}_{1} & {b}_{2}\end{matrix} ] ;$$

rank 6 8Tx precoding matrix:

$${W}_{8 Tx , 6} = \frac{1}{\sqrt{12 MN}} \times [ \begin{matrix}{b}_{0 , 0} & {b}_{0 , 1} & {b}_{0 , 2} & {b}_{1 , 0} & {b}_{1 , 1} & {b}_{1 , 2} \\ {φ}_{l} {b}_{0 , 0} & - {φ}_{l} {b}_{0 , 1} & {φ}_{l} {b}_{0 , 2} & - {φ}_{l} {b}_{1 , 0} & {b}_{1 , 1} & - {b}_{1 , 2}\end{matrix} ] or$$

$${W}_{8 Tx , 6} = \frac{1}{\sqrt{12 MN}} \times [ \begin{matrix}{b}_{0} & {b}_{0} & {b}_{1} & {b}_{1} & {b}_{2} & {b}_{2} \\ {φ}_{l} {b}_{0} & - {φ}_{l} {b}_{0} & {φ}_{l} {b}_{1} & - {φ}_{l} {b}_{1} & {b}_{2} & - {b}_{2}\end{matrix} ] ;$$

rank 7 8Tx precoding

$${W}_{8 Tx , 7} = \frac{1}{\sqrt{14 MN}} \times [ \begin{matrix}{b}_{0 , 0} & {b}_{0 , 1} & {b}_{0 , 2} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & {b}_{1 , 0} & - {b}_{1 , 1} & {b}_{1 , 2} & - {b}_{1 , 3}\end{matrix} ] or$$

$${W}_{8 Tx , 7} = \frac{1}{\sqrt{14 MN}} \times [ \begin{matrix}{b}_{0} & {b}_{0} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & {b}_{2} & - {b}_{2} & {b}_{3} & - {b}_{3}\end{matrix} ] ;$$

rank 8 8Tx precoding matrix:

$${W}_{8 Tx , 8} = \frac{1}{\sqrt{16 MN}} \times [ \begin{matrix}{b}_{0 , 0} & {b}_{0 , 1} & {b}_{0 , 2} & {b}_{0 , 3} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & - {φ}_{l} {b}_{0 , 3} & {b}_{1 , 0} & - {b}_{1 , 1} & {b}_{1 , 2} & - {b}_{1 , 3}\end{matrix} ] or$$

$${W}_{8 Tx , 8} = \frac{1}{\sqrt{16 MN}} \times [ \begin{matrix}{b}_{0} & {b}_{0} & {b}_{1} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & - {φ}_{l} {b}_{1} & {b}_{2} & - {b}_{2} & {b}_{3} & - {b}_{3}\end{matrix} ] ,$$

where, each of {b₀}, {b₀, b₁}, {b₀, b₁, b₂} and {b₀, b₁, b₂, b₃} is the one 4Tx precoding matrix, each pair of {b_{0,0}, b_{0,1}} and {b_{0,0}, b_{0,1}, b_{1,2}}, {b_{0,0}, b_{0,1}, b_{0,2}} and {b_{0,0}, b_{1,1}, b_{1,2}}, {b_{0,0}, b_{0,1}, b_{0,2}} and {b_{1,0}, b_{1,1}, b_{1,2}, b_{1,3}}, and {b_{0,0}, b_{0,1}, b_{0,2}, b_{0,3}} and {b_{1,0}, b_{1,1}, b_{1,2}, b_{1,3}} is the two 4Tx precoding matrices, φₗ is the co-phasing coefficient, and M indicates the number of antennas in horizontal, and N indicates the number of antennas in vertical.

In some embodiment, the TPMI field further indicates the rank of the scheduled PUSCH transmission.

In another embodiment, a method performed at a UE comprises receiving a DCI scheduling PUSCH transmission with 8 antenna ports, wherein the DCI includes a TPMI field indicating one or two 4Tx precoding matrices and a co-phasing coefficient; and determining a 8Tx precoding matrix for the scheduled PUSCH transmission according to the TPMI field.

In still another embodiment, a base unit comprises a transceiver; and a processor coupled to the transceiver, wherein the processor is configured to transmit, via the transceiver, a DCI scheduling a PUSCH transmission with 8 antenna ports, wherein the DCI includes a TPMI field indicating one or two 4Tx precoding matrices and a co-phasing coefficient; and determine the precoding matrix for the scheduled PUSCH transmission according to the TPMI field.

In yet another embodiment, a method performed at a base unit comprises transmitting a DCI scheduling a PUSCH transmission with 8 antenna ports, wherein the DCI includes a TPMI field indicating one or two 4Tx precoding matrices and a co-phasing coefficient; and determining the precoding matrix for the scheduled PUSCH transmission according to the TPMI field.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of antenna layout 1-a and antenna layout 1-b;

FIG. 2 is a schematic flow chart diagram illustrating an embodiment of a method;

FIG. 3 is a schematic flow chart diagram illustrating an embodiment of another method; and

FIG. 4 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

The UE can be configured in two different modes for PUSCH multi-antenna precoding, referred as codebook (CB) based transmission and non-codebook (nCB) based transmission, respectively. When the UE is configured with codebook based PUSCH transmission, one SRS resource set used for codebook can be configured in a BWP of a cell for the UE. When the UE is configured with non-codebook based PUSCH transmission, one SRS resource set used for non-codebook can be configured in a BWP of a cell for the UE.

To enable codebook based PUSCH transmission, the UE shall be configured to transmit one or more SRS resources used for codebook for uplink channel measurement. Based on the measurements on the configured SRS resources transmitted by the UE, the gNB determines a suitable rank and the precoding matrix from a pre-defined codebook, which includes a set of precoding matrices with different ranks, and sends the information, i.e., the transmit precoding matrix and number of layers information, to the UE when scheduling a PUSCH transmission.

For non-codebook based PUSCH transmission, the UE is required to measure a CSI-RS to obtain the uplink channel information based on channel reciprocity. In this case, a CSI-RS resource, which is a DL reference signaling transmitted by the gNB for DL channel measurement, is associated with the SRS resource set used for non-codebook. The UE selects what it believes is a suitable uplink precoder and applies the selected precoder to a set of configured SRS resources with one SRS resource transmitted on each layer defined by the precoder. Based on the received SRS resources, the gNB decides to modify the UE-selected precoder for the scheduled PUSCH transmission.

When a UE is equipped with 8 antenna ports (e.g., PUSCH or SRS antenna ports), the base unit (e.g., gNB) may send to the UE a DCI (e.g., DCI with format 0_1 or DCI with format 0_2) scheduling a PUSCH transmission with up to 8 spatial layers (i.e., PUSCH layers). The 8 antenna ports (e.g., PUSCH or SRS antenna ports) may be numbered as PUSCH or SRS antenna ports 1000, 1001, 1002, 1003, 1004, 1005, 1006, and 1007.

When a PUSCH is transmitted from the UE with 8 antenna ports, a precoding matrix is used to perform UL precoding on modulated data in codebook based PUSCH transmission. The UE shall perform UL precoding according to Equation 1.

$$[ \begin{matrix}\begin{matrix}{z}_{0}^{( {P}_{0} )} ( i ) \\ ⋮\end{matrix} \\ {z}_{0}^{( {P}_{ρ - 1} )} ( i )\end{matrix} ] = {W}_{0} [ \begin{matrix}\begin{matrix}{y}_{0}^{( 0 )} ( i ) \\ ⋮\end{matrix} \\ {y}_{0}^{( {v}_{0} - 1 )} ( i )\end{matrix} ] \qquad Equation 1$$

where, the block of vector

$${[ \begin{matrix}{y}_{0}^{( 0 )} ( i ) & ⋯ & {y}_{0}^{( {v}_{0} - 1 )} ( i )\end{matrix} ]}^{T}$$

is the modulated data that will be transmitted for the scheduled PUSCH transmission occasion i; W₀ is the precoding matrix applied to the block of vector; and the block of vector

$${[ \begin{matrix}{z}_{0}^{( {P}_{0} )} ( i ) & ⋯ & {z}_{0}^{( {P}_{ρ - 1} )} ( i )\end{matrix} ]}^{T}$$

is the pre-coded data to be transmitted by the UE. v₀ indicates the number of PUSCH layers. P₀ corresponds to PUSCH antenna port 1000 and P_{ρ-1} corresponds to PUSCH antenna port 1000+ρ−1. In this invention, p=8.

Coherent transmission is described as follows:

If a UE reports a capability of fully-coherent and 8 antenna ports (i.e., PUSCH antenna port 1000, 1001, 1002, 1003, 1004, 1005, 1006 and 1007), all 8 PUSCH antenna ports can be used for coherent transmission of a PUSCH layer. For example, the precoding vector used for each layer can have 8 non-zero elements, e.g.,

$$W = {\frac{1}{2 \sqrt{2}} [ 1 , j , 1 , j , 1 , j , 1 , j ]}^{T}$$

is a valid precoding vector for a rank 1 PUSCH transmission (where, each rank corresponds to a PUSCH layer) with 8 fully-coherent antenna ports. If the phase difference between any two antenna ports among multiple antenna ports is fixed, the multiple antenna ports are coherent. If the phase difference between any two antenna ports among multiple antenna ports is not fixed, the multiple antenna ports are non-coherent.

The antenna layout 1-a and antenna layout 1-b illustrated in FIG. 1 are dual-polarized antenna layouts for fully coherent UE with eight antenna ports (i.e., fully coherent 8Tx UE). M indicates the number of antennas in horizontal, and N indicates the number of antennas in vertical. For antenna layout 1-a, M=2 and N=2. For antenna layout 1-b, M=4 and N=1. In this specification, one antenna corresponds to one antenna port. It means that M also indicates the number of antenna ports in horizontal, and N indicates the number of antenna ports in vertical.

The UE can report the supported maxRank∈{1, 2, 3, 4, 5, 6, 7, 8}, i.e., the supported maximum number of PUSCH layers for a PUSCH transmission.

The gNB sends a DCI to the UE to schedule one or more PUSCH transmissions. The rank of the scheduled PUSCH transmission may be 1, 2, 3, 4, 5, 6, 7 or 8 depending on the reported maxRank. It means that the PUSCH transmission has L PUSCH layers, where L is equal to the indicated rank, which is equal to or less than the reported maxRank. A precoding matrix (which can also be referred to as precoder) shall be determined for the scheduled PUSCH transmission.

The number of columns of the precoding matrix is equal the number of layers (i.e., the rank) of a PUSCH transmission for which the precoding matrix can be applied. So, precoding matrix (i.e., precoder) can be further described as rank R precoding matrix (precoder), e.g., rank 1 precoder, rank 2 precoder, rank 3 precoder, rank 4 precoder, rank 5 precoder, rank 6 precoder, rank 7 precoder, rank 8 precoder. Rank R precoding matrix (precoder) can be also denoted as R-layer precoding matrix (precoder), e.g., one-layer precoder (or single-layer precoder), two-layer precoder, three-layer precoder, four-layer precoder, five-layer precoder, six-layer precoder, seven-layer precoder, eight-layer precoder. The number of rows of the precoding matrix (precoder) is equal to the number of antenna ports for which the precoding matrix can be applied. For example, the precoding matrix (precoder) shall have 8 rows (denoted as 8Tx) for a UE with 8 antenna ports.

A first embodiment relates to rank 1 precoder (W_{8Tx,1}), rank 2 precoder (W_{8Tx,2}), rank 3 precoder (W_{8Tx,3}), and rank 4 precoder (W_{8Tx,4}) for fully coherent UE (i.e., 8Tx UE), and the corresponding indication by TPMI field.

$${W}_{8 T x , 1} = \frac{1}{\sqrt{2 M N}} \times [ \begin{matrix}{b}_{0} \\ {φ}_{l} {b}_{0}\end{matrix} ]$$

$${W}_{8 Tx , 2} = \frac{1}{\sqrt{4 M N}} \times [ \begin{matrix}{b}_{0} & {b}_{1} \\ {ϕ}_{l} {b}_{0} & - {φ}_{l} {b}_{1}\end{matrix} ]$$

$${W}_{8 T x , 3} = \frac{1}{\sqrt{6 M N}} \times [ \begin{matrix}{b}_{0} & {b}_{1} & {b}_{2} \\ {φ}_{l} {b}_{0} & {φ}_{l} {b}_{1} & - {φ}_{l} {b}_{2}\end{matrix} ]$$

$${W}_{8 T x , 4} = \frac{1}{\sqrt{8 M N}} \times [ \begin{matrix}{b}_{0} & {b}_{1} & {b}_{2} & {b}_{3} \\ {φ}_{l} {b}_{0} & {φ}_{l} {b}_{1} & - {φ}_{l} {b}_{2} & - {φ}_{l} {b}_{3}\end{matrix} ]$$

M indicates the number of antennas in horizontal, and N indicates the number of antennas in vertical. For fully coherent UE, M=2 and N=2 for antenna layout 1-a, or M=4 and N=1 for antenna layout 1-b. It means that MN=4.

Each of b₀, b₁, b₂, and b₃ is a 4Tx precoding vector for each PUSCH layer. W₁={b₀} is a rank 1 4Tx precoding matrix for antennas in a same polarization. W₂={b₀, b₁} is a rank 2 4Tx precoding matrix for antennas in a same polarization. W₃={b₀, b₁, b₂} is a rank 3 4Tx precoding matrix for antennas in a same polarization. W₄={b₀, b₁, b₂, b₃} is a rank 4 4Tx precoding matrix for antennas in a same polarization.

There are two schemes (i.e., Scheme 1 and Scheme 2) to determine W₁, W₂, W₃, and W₄.

### (1) Scheme 1:

For rank 1, for fully coherent only transmission, W₁={b₀} corresponds to a matrix (one of 16 candidates) provided in Table 2 for DFT-s-OFDM based PUSCH transmission or a matrix (one of 16 candidates) provided in Table 3 for CP-OFDM based PUSCH transmission; and for fully and partial and non-coherent transmission, W₁={b₀} corresponds to a matrix (one of 28 candidates) provided in Table 6.3.1.5-2 for DFT-s-OFDM without coefficient or a matrix (one of 28 candidates) provided in Table 6.3.1.5-3 for CP-OFDM of TS38.211 without coefficient.

Note that all of the tables are listed at the end of this specification.

For rank 2, for fully coherent only transmission, W₂={b₀, b₁} corresponds to a matrix (one of 8 candidates) provided in Table 4; and for fully and partial and non-coherent transmission, W₂={b₀, b₁} corresponds to a matrix (one of 22 candidates) provided in Table 6.3.1.5-5 without coefficient.

For rank 3, for fully coherent only transmission, W₃={b₀, b₁, b₂} corresponds to a matrix (one of 4 candidates) provided in Table 5; and for fully and partial and non-coherent transmission, W₃={b₀, b₁, b₂} corresponds to a matrix (one of 7 candidates) provided in Table 6.3.1.5-6 without coefficient.

For rank 4, for fully coherent only transmission, W₄={b₀, b₁, b₂, b₃} corresponds to a matrix (one of 2 candidates) provided in Table 6; and for fully and partial and non-coherent transmission, W₄={b₀, b₁, b₂, b₃} corresponds to a matrix (one of 5 candidates) provided in Table 6.3.1.5-7 without coefficient.

For Scheme 1, it can be seen that, for fully coherent only transmission, all the elements of the 8Tx precoding matrix are non-zero values (see Tables 2 to 6), i.e., all the 8 antennas are used for each PUSCH layer transmission. On the other hand, for fully and partial and non-coherent transmission, some elements of the 8Tx precoding matrix may be zero (see Tables 6.3.1.5-2, 6.3.1.5-3, 6.3.1.5-5, 6.3.1.5-6 and 6.3.1.5-7), i.e., it is possible that only partial antenna port(s) are used for a PUSCH layer transmission.

### (2) Scheme 2:

For rank 1, W₁={b₀} corresponds to a matrix (i.e., vector) (one of 16 candidates) provided by the 3^{rd} column in Table 1.

For rank 2, W₂={b₀, b₁} corresponds to a matrix (one of 16 candidates) provided by the 4^{th} column in Table 1.

For rank 3, W₃={b₀, b₁, b₂} corresponds to a matrix (one of 16 candidates) provided by the 5^{th} column in Table 1.

For rank 4, W₄={b₀, b₁, b₂, b₃} corresponds to a matrix (one of 16 candidates) provided by the 6^{th} column in Table 1.

For Scheme 2, it can be seen that only fully coherent transmission is supported, that is, all the elements of the 8Tx precoding matrix are non-zero values.

φₗ=e^{jπn/2}∈{1,j, −1, −j} corresponding to l∈{0,1,2,3} is the co-phasing coefficient between two polarizations. For rank 1, l∈{0,1,2,3}→φₗ=e^{jπn/2}∈{1,j, −1, −j}. It means that there are 4 candidates for φₗ for rank 1. For rank 2, rank 3, and rank 4, l∈{0,1}→φₗ=e^{jπn/2}∈{1,j}. It means that there are 2 candidates for φₗ for each of rank 2, rank 3 and rank 4. As a whole, the co-phasing coefficient φₗ is calculated based on the index 1. In the following description, φₗ may be abbreviated as φ.

In the first embodiment, the precoder for maxRank=4 (i.e., rank≤4) for 8Tx UE is determined according to a 4Tx precoding matrix and a co-phasing coefficient cp.

The TPMI indication of the rank 1 precoder (W_{Tx,1}), the rank 2 precoder (W_{8Tx,2}), the rank 3 precoder (W_{8Tx,3}), and the rank 4 precoder (W_{Tx,4}) for fully coherent UE (i.e., 8Tx UE) is described as follows.

For rank≤4 (i.e., rank 1, rank 2, rank 3 and rank 4), if the rank of the scheduled PUSCH can be obtained from other field (i.e., not the TPMI field) of the scheduling DCI, the TPMI field of the scheduling DCI only needs to indicate the 4Tx precoding matrix (i.e., W₁, W₂, W₃, and W₄) and the co-phasing coefficient (i.e., φₗ). For fully coherent only transmission, depending on the candidates for W and the candidiates for φₗ for each of rank 1, rank 2, rank 3 and rank 4, the required TPMI indication overhead for “Scheme 1, fully coherent only transmission”, “Scheme 1, fully and partial and non-coherent transmission” and “Scheme 2 (fully coherent only transmission)” are provided in Table 7.

For example, for “Scheme 1, fully coherent only transmission” and Rank 2, the candidates for W₂ are eight (8) (see Table 4) and the candidates for φₗ (i.e., the candidates for the index l) are two (2). So, the required TPMI indication overhead for W₂ and φₗ is log₂(8)+log₂(2)=3+1=4 bits.

For another example, for “Scheme 1, fully and partial and non-coherent transmission” and Rank 1, the candidates for W₁ are eight (28) (see Table 6.3.1.5-2 or 6.3.1.5-3) and the candidates for φₗ (i.e., the candidates for the index l) are four (4). So, the required TPMI indication overhead for W₁ and φₗ is [log₂(28)]+log₂(4)=5+2=7 bits.

As a whole, if the rank of the scheduled PUSCH can be obtained from other field (that is, not TPMI field) of the scheduling DCI, the TPMI field, used for indicating the 4Tx precoding matrix (i.e., W₁, W₂, W₃, and W₄) and the co-phasing coefficient (i.e., φₗ), shall have 6 (=4+2) bits (i.e., the maximum overhead among rank 1, rank 2, rank 3 and rank 4 for fully coherent only transmission for both Scheme 1 and Scheme 2) or 7 (=5+2) bits (i.e., the maximum overhead among rank 1, rank 2, rank 3 and rank 4 for fully and partial and non-coherent transmission for Scheme 1).

On the other hand, if the rank, the 4Tx precoding matrix (i.e., W₁, W₂, W₃, and W₄) and the co-phasing coefficient (i.e., φₗ) are jointed coded in the TPMI field (i.e., each TPMI field codepoint indicates a different combination of the rank, the 4Tx precoding matrix and the co-phasing coefficient), the total number of candidate 8Tx precoding matrices for maxRank=4 (i.e., for rank≤4) for “Scheme 1, fully coherent only transmission” is 16×4+8×2+4×2+2×2=92. It implies that the TPMI overhead will be [log₂(92)]=7 bits. If the rank is also jointly indicated in the TMPI field along with the 4Tx precoding matrix and the co-phasing coefficient, the TMPI field can be alternatively referred to as ‘index of transmit precoding matrix and rank’ field. Table 8 illustrates joint precoding matrix, co-phasing coefficient and transmit rank indicated for “Scheme 1, fully coherent only transmission” with maxRank=4. Note that, in Table 8, ‘1 layer’, ‘2 layers’, ‘3 layers’ and ‘4 layers’ correspond to rank 1, rank 2, rank 3 and rank 4 respectively; TMPI indicates a matrix in Table 2 or 3 or 4 or 5 or 6 without coefficient; and each l (l=0, 1, 2 or 3) corresponds a different φₗ. For example, index ‘0’ of the ‘index of transmit precoding matrix and rank’ field indicates rank 1 (i.e., 1 layer), 4Tx precoding matrix

$$[ \begin{matrix}1 \\ 1 \\ 1 \\ - 1\end{matrix} ] or [ \begin{matrix}1 \\ 1 \\ 1 \\ 1\end{matrix} ]$$

(the matrix without coefficient in Table 2 or Table 3 indicated by TPMI=0), and the co-phasing coefficient 1 (calculated according to φₗ=e^{jπn/2} when l=0).

Similarly, if the rank, the 4Tx precoding matrix (i.e., W₁, W₂, W₃, and W₄) and the co-phasing coefficient (i.e., φₗ) are jointly coded (i.e., each TPMI field codepoint indicates a different combination of the rank, the 4Tx precoding matrix and the co-phasing coefficient), the total number of candidate 8Tx precoding matrices for maxRank=4 (i.e., for rank≤4) for “Scheme 2 (fully coherent only transmission)” is 16×4+16×2+16×2+16×2=160. It implies that the TPMI overhead will be [loh₂(160)]=8 bits. Similarly, if the rank is also jointly indicated in the TMPI field along with the 4Tx precoding matrix and the co-phasing coefficient, the TMPI field can be alternatively referred to as ‘index of transmit precoding matrix and rank’ field. Table 9 illustrates joint precoding matrix, co-phasing coefficient and transmit rank indicated for “Scheme 2 (fully coherent only transmission)” with maxRank=4. Note that, in Table 9, ‘1 layer’, ‘2 layers’, ‘3 layers’ and ‘4 layers’ correspond to rank 1, rank 2, rank 3 and rank 4 respectively; TMPI indicates a matrix in the 3^{rd}, 4^{th}, 5^{th}, or 6^{th} column in Table 1; and each l (l=0, 1, 2 or 3) corresponds a different φₗ.

A second embodiment relates to rank 5 precoder (W_{8Tx,5}), rank 6 precoder (W_{8Tx,6}), rank 7 precoder (W_{8Tx,7}), and rank 8 precoder (W_{8Tx,8}) for fully coherent UE (i.e., 8Tx UE), and the corresponding indication by TPMI field.

$${W}_{8 T x , 5} = \frac{1}{\sqrt{10 M N}} \times [ \begin{matrix}{b}_{0 , 0} & {b}_{0 , 1} & {b}_{1 , 0} & {b}_{1 , 1} & {b}_{1 , 2} \\ {φ}_{l} {b}_{0 , 0} & - {φ}_{l} {b}_{0 , 1} & {b}_{1 , 0} & - {b}_{1 , 1} & {b}_{1 , 2}\end{matrix} ]$$

$${W}_{8 T x , 6} = \frac{1}{\sqrt{12 M N}} \times [ \begin{matrix}{b}_{0 , 0} & {b}_{0 , 1} & {b}_{0 , 2} & {b}_{1 , 0} & {b}_{1 , 1} & {b}_{1 , 2} \\ {φ}_{l} {b}_{0 , 0} & - {φ}_{l} {b}_{0 , 1} & {φ}_{l} {b}_{0 , 2} & - {φ}_{l} {b}_{1 , 0} & {b}_{1 , 1} & - {b}_{1 , 2}\end{matrix} ]$$

$${W}_{8 T x , 7} = \frac{1}{\sqrt{14 M N}} \times [ \begin{matrix}{b}_{0 , 0} & {b}_{0 , 1} & {b}_{0 , 2} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & {b}_{1 , 0} & - {b}_{1 , 1} & {b}_{1 , 2} & - {b}_{1 , 3}\end{matrix} ]$$

$${W}_{8 T x , 8} = \frac{1}{\sqrt{16 M N}} \times [ \begin{matrix}{b}_{0 , 0} & {b}_{0 , 1} & {b}_{0 , 2} & {b}_{0 , 3} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & - {φ}_{l} {b}_{0 , 3} & {b}_{1 , 0} & - {b}_{1 , 1} & {b}_{1 , 2} & - {b}_{1 , 3}\end{matrix} ]$$

M indicates the number of antennas in horizontal, and N indicates the number of antennas in vertical. For fully coherent UE, M=2 and N=2 for antenna layout 1-a, or M=4 and N=1 for antenna layout 1-b. It means that MN=4.

It is assumed that two codewords shall be transmitted for more than 4 layers PUSCH transmission (i.e., rank 5, rank 6, rank 7 and rank 8). Each codeword is transmitted by 4 layers or less. Codeword-specific TPMI indication is adopted in the second embodiment. It means that the TPMI field of the scheduling DCI indicates two 4Tx precoding matrices, where each 4Tx precoding matrix is a rank 2 or rank 3 or rank 4 4Tx precoding matrix, and a co-phasing coefficient (i.e., φₗ) (which corresponds to a co-phasing coefficient index (i.e., l)).

In particular, for rank 5, a rank 2 4Tx precoding matrix W_{5,1}={b_{0,0}, b_{0,1}} and a rank 3 4Tx precoding matrix W_{5,2}={b_{1,0}, b_{1,1}, b_{1,2}} and a co-phasing coefficient are indicated. For rank 6, two rank 3 4Tx precoding matrices W_{6,1}={b_{0,0}, b_{0,1}, b_{0,2}} and W_{6,2}={b_{1,0}, b_{1,1}, b_{1,2}} and a co-phasing coefficient are indicated. For rank 7, a rank 3 4Tx precoding matrix W_{7,1}={b_{0,0}, b_{0,1}, b_{0,2}} and a rank 4 4Tx precoding matrix W_{7,2}={b_{1,0}, b_{1,1}, b_{1,2}, b_{1,3}} and a co-phasing coefficient are indicated. For rank 8, two rank 4 4Tx precoding matrices W_{8,1}={b_{0,0}, b_{0,1}, b_{0,2}, b_{0,3}} and W_{8,2}={b_{1,0}, b_{1,1}, b_{1,2}, b_{1,3}} and a co-phasing coefficient are indicated.

Since only rank 2, rank 3 and rank 4 4Tx precoding matrices are used to compose rank 5, rank 6, rank 7 and rank 8 8Tx precoding matrices, for both Scheme 1 and Scheme 2, l∈{0,1}→φₗ=e^{jπn/2}∈{1,j}. It means that there are 2 candidates for φₗ for each of rank 5, rank 6, rank 7 and rank 8.

In Scheme 1, for fully coherent only transmission, the rank 2 4Tx precoding matrix W_{5,1}={b_{0,0}, b_{0,1}} corresponds to a matrix (one of 8 candidates) provided in Table 4; each of the rank 3 4Tx precoding matrix W_{5,2}={b_{1,0}, b_{1,1}, b_{1,2}}, W_{6,1}={b_{0,0}, b_{0,1}, b_{0,2}}, W_{6,2}={b_{1,0}, b_{0,1}, b_{1,2}} and W_{7,1}={b_{0,0}, b_{0,1}, b_{0,2}} corresponds to a matrix (one of 4 candidates) provided in Table 5; and each of the rank 4 4Tx precoding matrix W_{7,2}={b_{1,0}, b_{1,1}, b_{1,2}, b_{1,3}}, W_{8,1}={b_{0,0}, b_{0,1}, b_{0,2}, b_{0,3}} and W_{8,2}={b_{1,0}, b_{1,1}, b_{1,2}, b_{1,3}} corresponds to a matrix (one of 2 candidates) provided in Table 6.

In Scheme 1, for fully and partial and non-coherent transmission, the rank 2 4Tx precoding matrix W_{5,1}={b_{0,0}, b_{0,1}} corresponds to a matrix (one of 22 candidates) provided in Table 6.3.1.5-5 without coefficient; each of the rank 3 4Tx precoding matrix W₅,2={b_{1,0}, b_{1,1}, b_{1,2}}, W_{6,1}={b_{0,0}, b_{0,1}, b_{0,2}}, W_{6,2}={b_{1,0}, b_{1,1}, b_{1,2}} and W_{7,1}={b_{0,0}, b_{0,1}, b_{0,2}} corresponds to a matrix (one of 7 candidates) provided in Table 6.3.1.5-6 without coefficient; and each of the rank 4 4Tx precoding matrix W_{7,2}={b_{1,0}, b_{1,1}, b_{1,2}, b_{1,3}}, W_{8,1}={b_{0,0}, b_{0,1}, b_{0,2}, b_{0,3}} and W_{8,2}={b_{1,0}, b_{1,1}, b_{1,2}, b_{1,3}} corresponds to a matrix (one of 5 candidates) provided in Table 6.3.1.5-7 without coefficient.

In Scheme 2 (for fully coherent only transmission), the rank 2 4Tx precoding matrix W_{5,1}={b_{0,0}, b_{0,1}} corresponds to a matrix (one of 16 candidates) provided by the 4^{th} column in Table 1; each of the rank 3 4Tx precoding matrix W_{5,2}={b_{1,0}, b_{1,0}, b_{1,1}, b_{1,2}}, W_{6,1}={b_{0,0}, b_{0,1}, b_{0,2}}, W_{6,2}={b_{1,0}, b_{1,1}, b_{2,1}} and W_{7,1}={b_{0,0}, b_{0,1}, b_{0,2}} corresponds to a matrix (one of 16 candidates) provided by the 5^{th} column in Table 1; and each of the rank 4 4Tx precoding matrix W_{7,2}={b_{1,0}, b_{1,1}, b_{1,2}, b_{1,3}}, W_{8,1}={b_{0,0}, b_{0,1}, b_{0,2}, b_{0,3}} and W_{8,2}={b_{1,0}, b_{1,1}, b_{1,2}, b_{1,3}} corresponds to a matrix (one of 16 candidates) provided by the 6^{th} column in Table 1.

Table 10 illustrates TPMI field overhead for rank 1 to rank 8. In particular, the TPMI field overheads for rank 1, rank 2, rank 3 and rank 4 are substantially the same contents as Table 7. It is assumed that the DCI schedules a PUSCH transmission with rank 1, rank 2, rank 3 and rank 4 with a same TPMI field interpretation (i.e., for rank 1/2/3/4). So, the TPMI field shall have a bit length that is the longest among rank 1, rank 2, rank 3 and rank 4. It means that, for “Scheme 1, fully coherent only transmission”, the bit length for rank 1/2/3/4 shall be 6 bits=W(4 bits)+φ(2 bits) (which the same as “Rank 1”); and for “Scheme 1, Fully and Partial and Non-coherent transmission”, the bit length for rank 1/2/3/4 shall be 7 bits=W(5 bits)+(2 bits) (which the same as “Rank 1”); and for “Scheme 2 (fully coherent only transmission)”, the bit length for rank 1/2/3/4 shall be 6 bits=W(4 bits)+φ(2 bits) (which the same as “Rank 1”).

The TPMI field overheads for rank 5, rank 6, rank 7 and rank 8 are calculated according to the overheads for two 4Tx precoding matrices and the co-phasing coefficient. It is assumed that the DCI schedules a PUSCH transmission with rank 5, rank 6, rank 7 and rank 8 with a same TPMI field interpretation (i.e., for rank 5/6/7/8). So, the TPMI field shall have a bit length that is the longest among rank 5, rank 6, rank 7 and rank 8. It means that, for “Scheme 1, fully coherent only transmission”, the bit length for rank 5/6/7/8 shall be 6 bits=W_{ri,1}(3 bits)+W_{ri,2}(2 bits)+φ(1 bit) (which the same as “Rank 5”); for “Scheme 1, Fully and Partial and Non-coherent transmission”, the bit length for rank 5/6/7/8 shall be 9 bits=W_{ri,1}(5 bits)+W_{ri,2}(3 bits)+φ(1 bit) (which the same as “Rank 5”); and for “Scheme 2 (fully coherent only transmission)”, the bit length for rank 5/6/7/8 shall be 9 bits=W_{ri,1}(4 bits)+W_{ri,2}(4 bits)+φ(1 bit) (which the same as “Rank 5” or “Rank 6” or “Rank 7” or “Rank 8”).

A third embodiment relates to another proposal of rank 5 precoder (W_{8Tx,5}), rank 6 precoder (W_{8Tx,6}), rank 7 precoder (W_{8Tx,7}), and rank 8 precoder (W_{8Tx,8}) for fully coherent UE (i.e., 8Tx UE), and the corresponding indication by TPMI field.

In the second embodiment, each of the rank 5 precoder (W_{8Tx,5}), the rank 6 precoder (W_{8Tx,6}), the rank 7 precoder (W_{8Tx,7}), and the rank 8 precoder (W_{8Tx,8}) is composed according to two 4Tx precoding matrices as well as the co-phasing coefficient. In the third embodiment, each of the rank 5 precoder (W_{8Tx,8}), the rank 6 precoder (W_{8Tx,6}), the rank 7 precoder (W_{8Tx,7}), and the rank 8 precoder (W_{8Tx,8}) is composed according to only one 4Tx precoding matrix as well as the co-phasing coefficient as follows.

$${W}_{8 T x , 5} = \frac{1}{\sqrt{10 M N}} \times [ \begin{matrix}{b}_{0} & {b}_{0} & {b}_{1} & {b}_{1} & {b}_{2} \\ {φ}_{l} {b}_{0} & - {φ}_{l} {b}_{0} & {b}_{1} & - {b}_{1} & {b}_{2}\end{matrix} ]$$

$${W}_{8 T x , 6} = \frac{1}{\sqrt{12 M N}} \times [ \begin{matrix}{b}_{0} & {b}_{0} & {b}_{1} & {b}_{1} & {b}_{2} & {b}_{2} \\ {φ}_{l} {b}_{0} & - {φ}_{l} {b}_{0} & {φ}_{l} {b}_{1} & - {φ}_{l} {b}_{1} & {b}_{2} & - {b}_{2}\end{matrix} ]$$

$${W}_{8 T x , 7} = \frac{1}{\sqrt{14 M N}} \times [ \begin{matrix}{b}_{0} & {b}_{0} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & {b}_{2} & - {b}_{2} & {b}_{3} & - {b}_{3}\end{matrix} ]$$

$${W}_{8 T x , 8} = \frac{1}{\sqrt{16 M N}} \times [ \begin{matrix}{b}_{0} & {b}_{0} & {b}_{1} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & - {φ}_{l} {b}_{1} & {b}_{2} & - {b}_{2} & {b}_{3} & - {b}_{3}\end{matrix} ]$$

M indicates the number of antennas in horizontal, and N indicates the number of antennas in vertical. For fully coherent UE, M=2 and N=2 for antenna layout 1-a, or M=4 and N=1 for antenna layout 1-b. It means that MN=4.

Since only rank 3 4Tx precoding matrix {b₀, b₁, b₂} and rank 4 4Tx precoding matrix {b₀, b₁, b₂, b₃} are used to compose rank 5, rank 6, rank 7 and rank 8 8Tx precoding matrices, for both Scheme 1 and Scheme 2, l∈{0,1}→φₗ=e^{jπn/2}∈{1,j}. It means that there are 2 candidates for φₗ for each of rank 5, rank 6, rank 7 and rank 8.

For rank 5, a rank 3 4Tx precoding matrix W₅={b₀, b₁, b₂} and a co-phasing coefficient are indicated. For rank 6, a rank 3 4Tx precoding matrix W₆={b₀, b₁, b₂} and a co-phasing coefficient are indicated. For rank 7, a rank 4 4Tx precoding matrix W₇={b₀, b₁, b₂, b₃} and a co-phasing coefficient are indicated. For rank 8, a rank 4 4Tx precoding matrix W₈={b₀, b₁, b₂, b₃} and a co-phasing coefficient are indicated.

In Scheme 1, for fully coherent only transmission, each of the rank 3 4Tx precoding matrix W₅={b₀, b₁, b₂} and W₆={b₀, b₁, b₂} corresponds to a matrix (one of 4 candidates) provided in Table 5; and each of the rank 4 4Tx precoding matrix W₇={b₀, b₁, b₂, b₃} and W₈={b₀, b₁, b₂, b₃} a matrix (one of 2 candidates) provided in Table 6.

In Scheme 1, for fully and partial and non-coherent transmission, each of the rank 3 4Tx precoding matrix W₅={b₀, b₁, b₂} and W₆={b₀, b₁, b₂} corresponds to a matrix (one of 7 candidates) provided in Table 6.3.1.5-6 without coefficient; and each of the rank 4 4Tx precoding matrix W₇={b₀, b₁, b₂, b₃} and W₈={b₀, b₁, b₂, b₃} corresponds to a matrix (one of 5 candidates) provided in Table 6.3.1.5-7 without coefficient.

In Scheme 2 (for fully coherent only transmission), each of the rank 3 4Tx precoding matrix W₅={b₀, b₁, b₂} and W₆={b₀, b₁, b₂} corresponds to a matrix (one of 16 candidates) provided by the 5^{th} column in Table 1; and each of the rank 4 4Tx precoding matrix W₇={b₀, b₁, b₂, b₃} and W₈={b₀, b₁, b₂, b₃} corresponds to a matrix (one of 16 candidates) provided by the 6^{th} column in Table 1.

Table 11 illustrates TPMI field overhead for rank 5 to rank 8 in the third embodiment. The TPMI field overheads for rank 5, rank 6, rank 7 and rank 8 are calculated according to the overheads for indicating the one 4Tx precoding matrix and the co-phasing coefficient. It is assumed that the DCI schedules a PUSCH transmission with rank 5, rank 6, rank 7 and rank 8 with a same TPMI field interpretation (i.e., for rank 5/6/7/8). So, the TPMI field shall have a bit length that is the longest among rank 5, rank 6, rank 7 and rank 8. It means that, for “Scheme 1, fully coherent only transmission”, the bit length for rank 5/6/7/8 shall be 3 bits=W (2 bits)+cp(1 bit) (which the sanme as “Rank 5” or “Rank 6”); and for “Scheme 1, Fully and Partial and Non-coherent transmission”, the bit length for rank 5/6/7/8 shall be 4 bits=W (3 bits)+φ(1 bit) (which the same as “Rank 5” or “Rank 6” or “Rank 7” or “Rank 8”); and for “Scheme 2 (fully coherent only transmission)”, the bit length for rank 5/6/7/8 shall be 5 bits=W (4 bits)+φ(1 bit) (which the same as “Rank 5” or “Rank 6” or “Rank 7” or “Rank 8”).

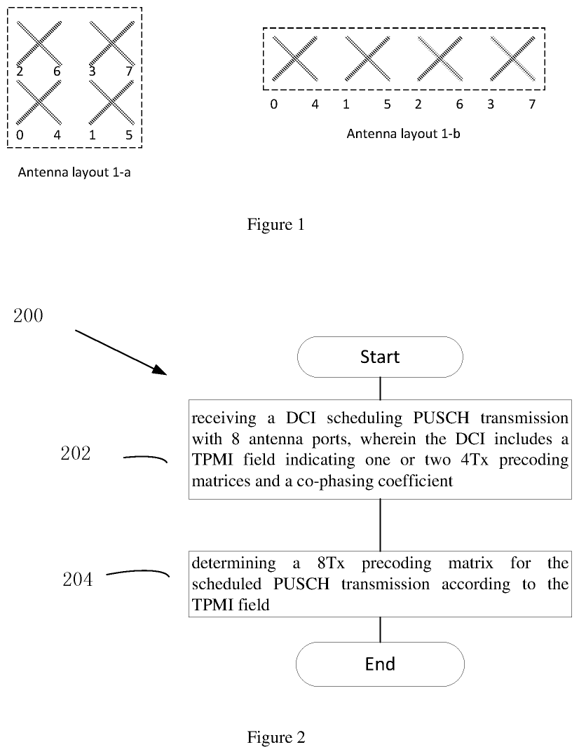

FIG. 2 is a schematic flow chart diagram illustrating an embodiment of a method 200 according to the present application. In some embodiments, the method 200 is performed by an apparatus, such as a remote unit (e.g., UE). In certain embodiments, the method 200 may be performed by a processor executing program code, for example, a microcontroller, a microprocessor, a CPU, a GPU, an auxiliary processing unit, a FPGA, or the like.

The method 200 is a method performed at a UE, comprising: 202 receiving a DCI scheduling PUSCH transmission with 8 antenna ports, wherein the DCI includes a TPMI field indicating one or two 4Tx precoding matrices and a co-phasing coefficient; and 204 determining a 8Tx precoding matrix for the scheduled PUSCH transmission according to the TPMI field.

In some embodiment, if the scheduled PUSCH transmission is rank 1 PUSCH transmission, the co-phasing coefficient is indicated as 1,j, −1 or j, and if the scheduled PUSCH transmission is rank 2, rank 3, rank 4, rank 5, rank 6, rank 7 and rank 8 PUSCH transmission, the co-phasing coefficient is indicated as 1 or j.

In some embodiment, if the scheduled PUSCH transmission is rank 1 PUSCH transmission, the one 4Tx precoding matrix is a rank 1 4Tx precoding matrix; if the scheduled PUSCH transmission is rank 2 PUSCH transmission, the one 4Tx precoding matrix is a rank 2 4Tx precoding matrix; if the scheduled PUSCH transmission is rank 3 PUSCH transmission, the one 4Tx precoding matrix is a rank 3 4Tx precoding matrix; if the scheduled PUSCH transmission is rank 4 PUSCH transmission, the one 4Tx precoding matrix is a rank 4 4Tx precoding matrix; if the scheduled PUSCH transmission is rank 5 PUSCH transmission, the one 4Tx precoding matrix is a rank 3 4Tx precoding matrix, or the two 4Tx precoding matrices are a rank 2 4Tx precoding matrix and a rank 3 4Tx precoding matrix; if the scheduled PUSCH transmission is rank 6 PUSCH transmission, the one 4Tx precoding matrix is a rank 3 4Tx precoding matrix, or the two 4Tx precoding matrices are two rank 3 4Tx precoding matrices; if the scheduled PUSCH transmission is rank 7 PUSCH transmission, the one 4Tx precoding matrix is a rank 4 4Tx precoding matrix, or the two 4Tx precoding matrices are a rank 3 4Tx precoding matrix and a rank 4 4Tx precoding matrix; and if the scheduled PUSCH transmission is rank 8 PUSCH transmission, the one 4Tx precoding matrix is a rank 4 4Tx precoding matrix, or the two 4Tx precoding matrices are two rank 4 4Tx precoding matrices.

In some embodiment, if the maximum number of PUSCH layers of the scheduled PUSCH transmission is less than or equal to 4, the length of the part for indicating the one 4Tx precoding matrix is 4 bits for fully coherent only transmission, and is 5 bits for fully and partial and non-coherent transmission, and if the maximum number of PUSCH layers of the scheduled PUSCH transmission is larger than 4, the length of the part for indicating the one 4Tx precoding matrix is 2 bits or 4 bits for fully coherent only transmission and is 3 bits for fully and partial and non-coherent transmission, or the length of the part for indicating the two 4Tx precoding matrices is 3+2 bits or 4+4 bits for fully coherent only transmission and is 5+3 bits for fully and partial and non-coherent transmission.

In some embodiment, the method further comprises reporting a maxRank=8.

In some embodiment, the 8Tx precoding matrix for each rank is:
rank 1 8Tx precoding matrix:

$${W}_{8 T x , 1} = \frac{1}{\sqrt{2 M N}} \times [ \begin{matrix}{b}_{0} \\ {φ}_{l} {b}_{0}\end{matrix} ] ;$$

rank 2 8Tx precoding matrix:

$${W}_{8 T x , 2} = \frac{1}{\sqrt{4 M N}} \times [ \begin{matrix}{b}_{0} & {b}_{1} \\ {φ}_{l} {b}_{0} & - {φ}_{l} {b}_{1}\end{matrix} ] ;$$

rank 3 8Tx precoding matrix:

$${W}_{8 T x , 3} = \frac{1}{\sqrt{6 M N}} \times [ \begin{matrix}{b}_{0} & {b}_{1} & {b}_{2} \\ {φ}_{l} {b}_{0} & {φ}_{l} {b}_{1} & - {φ}_{l} {b}_{2}\end{matrix} ] ;$$

rank 4 8Tx precoding matrix:

$${W}_{8 T x , 4} = \frac{1}{\sqrt{8 M N}} \times [ \begin{matrix}{b}_{0} & {b}_{1} & {b}_{2} & {b}_{3} \\ {φ}_{l} {b}_{0} & {φ}_{l} {b}_{1} & - {φ}_{l} {b}_{2} & - {φ}_{l} {b}_{3}\end{matrix} ] ;$$

rank 5 8Tx precoding matrix:

$${W}_{8 Tx , 5} = \frac{1}{\sqrt{10 MN}} \times [ \begin{matrix}{b}_{0 , 0} & {b}_{0 , 1} & {b}_{1 , 0} & {b}_{1 , 1} & {b}_{1 , 2} \\ {φ}_{l} {b}_{0 , 0} & - {φ}_{l} {b}_{0 , 1} & {b}_{1 , 0} & - {b}_{1 , 1} & {b}_{1 , 2}\end{matrix} ] or$$

$${W}_{8 Tx , 5} = \frac{1}{\sqrt{10 MN}} \times [ \begin{matrix}{b}_{0} & {b}_{0} & {b}_{1} & {b}_{1} & {b}_{2} \\ {φ}_{l} {b}_{0} & - {φ}_{l} {b}_{0} & {b}_{1} & - {b}_{1} & {b}_{2}\end{matrix} ] ;$$

rank 6 8Tx precoding matrix:

$${W}_{8 Tx , 6} = \frac{1}{\sqrt{12 MN}} \times [ \begin{matrix}{b}_{0 , 0} & {b}_{0 , 1} & {b}_{0 , 2} & {b}_{1 , 0} & {b}_{1 , 1} & {b}_{1 , 2} \\ {φ}_{l} {b}_{0 , 0} & - {φ}_{l} {b}_{0 , 1} & {φ}_{l} {b}_{0 , 2} & - {φ}_{l} {b}_{1 , 0} & {b}_{1 , 1} & - {b}_{1 , 2}\end{matrix} ] or$$

$${W}_{8 Tx , 6} = \frac{1}{\sqrt{12 MN}} \times [ \begin{matrix}{b}_{0} & {b}_{0} & {b}_{1} & {b}_{1} & {b}_{2} & {b}_{2} \\ {φ}_{l} {b}_{0} & - {φ}_{l} {b}_{0} & {φ}_{l} {b}_{1} & - {φ}_{l} {b}_{1} & {b}_{2} & - {b}_{2}\end{matrix} ] ;$$

rank 7 8Tx precoding matrix:

$${W}_{8 Tx , 7} = \frac{1}{\sqrt{14 MN}} \times [ \begin{matrix}{b}_{0 , 0} & {b}_{0 , 1} & {b}_{0 , 2} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & {b}_{1 , 0} & - {b}_{1 , 1} & {b}_{1 , 2} & - {b}_{1 , 3}\end{matrix} ] or$$

$${W}_{8 Tx , 7} = \frac{1}{\sqrt{14 MN}} \times [ \begin{matrix}{b}_{0} & {b}_{0} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & {b}_{2} & - {b}_{2} & {b}_{3} & - {b}_{3}\end{matrix} ] ;$$

rank 8 8Tx precoding matrix:

$${W}_{8 Tx , 8} = \frac{1}{\sqrt{16 MN}} \times [ \begin{matrix}{b}_{0 , 0} & {b}_{0 , 1} & {b}_{0 , 2} & {b}_{0 , 3} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & - {φ}_{l} {b}_{0 , 3} & {b}_{1 , 0} & - {b}_{1 , 1} & {b}_{1 , 2} & - {b}_{1 , 3}\end{matrix} ] or$$

$${W}_{8 Tx , 8} = \frac{1}{\sqrt{16 MN}} \times [ \begin{matrix}{b}_{0} & {b}_{0} & {b}_{1} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & - {φ}_{l} {b}_{1} & {b}_{2} & - {b}_{2} & {b}_{3} & - {b}_{3}\end{matrix} ] ,$$

where, each of {b₀}, {b₀, b₁}, {b₀, b₁, b₂} and {b₀, b₁, b₂, b₃} is the one 4Tx precoding matrix, each pair of {b_{0,0}, b_{0,1}} and {b_{1,0}, b_{1,1}, b_{2,1}}, {b_{0,0}, b_{0,1}, b_{0,2}} and {b_{1,0}, b_{1,1}, b_{1,2}}, {b_{0,0}, b_{0,1}, b_{0,2}} and {b_{1,0}, b_{1,1}, b_{1,2}, b_{1,3}}, and {b_{0,0}, b_{0,1} b_{0,2}, b_{0,3}} and {b_{1,0}, b_{1,1}b_{1,2}, b_{1,3}} is the two 4Tx precoding matrices, φₗ is the co-phasing coefficient, and M indicates the number of antennas in horizontal, and N indicates the number of antennas in vertical.

In some embodiment, the TPMI field further indicates the rank of the scheduled PUSCH transmission.

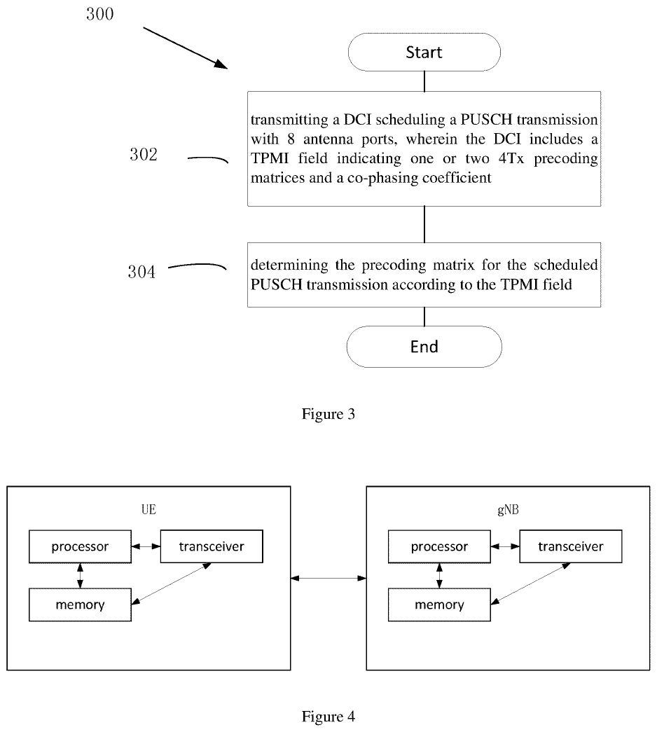

FIG. 3 is a schematic flow chart diagram illustrating an embodiment of a method 300 according to the present application. In some embodiments, the method 300 is performed by an apparatus, such as a base unit. In certain embodiments, the method 300 may be performed by a processor executing program code, for example, a microcontroller, a microprocessor, a CPU, a GPU, an auxiliary processing unit, a FPGA, or the like.

The method 300 may comprise 302 transmitting a DCI scheduling a PUSCH transmission with 8 antenna ports, wherein the DCI includes a TPMI field indicating one or two 4Tx precoding matrices and a co-phasing coefficient; and 304 determining the precoding matrix for the scheduled PUSCH transmission according to the TPMI field.

In some embodiment, if the scheduled PUSCH transmission is rank 1 PUSCH transmission, the co-phasing coefficient is indicated as 1,j, −1 or −j, and if the scheduled PUSCH transmission is rank 2, rank 3. rank 4. rank 5, rank 6, rank 7 and rank 8 PUSCH transmission, the co-phasing coefficient is indicated as 1 or j.

In some embodiment, if the scheduled PUSCH transmission is rank 1 PUSCH transmission, the one 4Tx precoding matrix is a rank 1 4Tx precoding matrix; if the scheduled PUSCH transmission is rank 2 PUSCH transmission, the one 4Tx precoding matrix is a rank 2 4Tx precoding matrix; if the scheduled PUSCH transmission is rank 3 PUSCH transmission, the one 4Tx precoding matrix is a rank 3 4Tx precoding matrix; if the scheduled PUSCH transmission is rank 4 PUSCH transmission, the one 4Tx precoding matrix is a rank 4 4Tx precoding matrix; if the scheduled PUSCH transmission is rank 5 PUSCH transmission, the one 4Tx precoding matrix is a rank 3 4Tx precoding matrix, or the two 4Tx precoding matrices are a rank 2 4Tx precoding matrix and a rank 3 4Tx precoding matrix; if the scheduled PUSCH transmission is rank 6 PUSCH transmission, the one 4Tx precoding matrix is a rank 3 4Tx precoding matrix, or the two 4Tx precoding matrices are two rank 3 4Tx precoding matrices; if the scheduled PUSCH transmission is rank 7 PUSCH transmission, the one 4Tx precoding matrix is a rank 4 4Tx precoding matrix, or the two 4Tx precoding matrices are a rank 3 4Tx precoding matrix and a rank 4 4Tx precoding matrix; and if the scheduled PUSCH transmission is rank 8 PUSCH transmission, the one 4Tx precoding matrix is a rank 4 4Tx precoding matrix, or the two 4Tx precoding matrices are two rank 4 4Tx precoding matrices.

In some embodiment, if the maximum number of PUSCH layers of the scheduled PUSCH transmission is less than or equal to 4, the length of the part for indicating the one 4Tx precoding matrix is 4 bits for fully coherent only transmission, and is 5 bits for fully and partial and non-coherent transmission, and if the maximum number of PUSCH layers of the scheduled PUSCH transmission is larger than 4, the length of the part for indicating the one 4Tx precoding matrix is 2 bits or 4 bits for fully coherent only transmission and is 3 bits for fully and partial and non-coherent transmission, or the length of the part for indicating the two 4Tx precoding matrices is 3+2 bits or 4+4 bits for fully coherent only transmission and is 5+3 bits for fully and partial and non-coherent transmission.

In some embodiment, the method further comprises receiving a maxRank=8.

In some embodiment, the 8Tx precoding matrix for each rank is:
rank 1 8Tx precoding matrix:

$${W}_{8 T x , 1} = \frac{1}{\sqrt{2 M N}} \times [ \begin{matrix}{b}_{0} \\ {φ}_{l} {b}_{0}\end{matrix} ] ;$$

rank 2 8Tx precoding matrix:

$${W}_{8 T x , 2} = \frac{1}{\sqrt{4 M N}} \times [ \begin{matrix}{b}_{0} & {b}_{1} \\ {φ}_{l} {b}_{0} & - {φ}_{l} {b}_{1}\end{matrix} ] ;$$

rank 3 8Tx precoding matrix:

$${W}_{8 T x , 3} = \frac{1}{\sqrt{6 M N}} \times [ \begin{matrix}{b}_{0} & {b}_{1} & {b}_{2} \\ {φ}_{l} {b}_{0} & {φ}_{l} {b}_{1} & - {φ}_{l} {b}_{2}\end{matrix} ] ;$$

rank 4 8Tx precoding matrix:

$${W}_{8 T x , 4} = \frac{1}{\sqrt{8 M N}} \times [ \begin{matrix}{b}_{0} & {b}_{1} & {b}_{2} & {b}_{3} \\ {φ}_{l} {b}_{0} & {φ}_{l} {b}_{1} & - {φ}_{l} {b}_{2} & - {φ}_{l} {b}_{3}\end{matrix} ] ;$$

rank 5 8Tx precoding matrix:

$${W}_{8 Tx , 5} = \frac{1}{\sqrt{10 MN}} \times [ \begin{matrix}{b}_{0 , 0} & {b}_{0 , 1} & {b}_{1 , 0} & {b}_{1 , 1} & {b}_{1 , 2} \\ {φ}_{l} {b}_{0 , 0} & - {φ}_{l} {b}_{0 , 1} & {b}_{1 , 0} & - {b}_{1 , 1} & {b}_{1 , 2}\end{matrix} ] or$$

$${W}_{8 Tx , 5} = \frac{1}{\sqrt{10 MN}} \times [ \begin{matrix}{b}_{0} & {b}_{0} & {b}_{1} & {b}_{1} & {b}_{2} \\ {φ}_{l} {b}_{0} & - {φ}_{l} {b}_{0} & {b}_{1} & - {b}_{1} & {b}_{2}\end{matrix} ] ;$$

rank 6 8Tx precoding matrix:

$${W}_{8 Tx , 6} = \frac{1}{\sqrt{12 MN}} \times [ \begin{matrix}{b}_{0 , 0} & {b}_{0 , 1} & {b}_{0 , 2} & {b}_{1 , 0} & {b}_{1 , 1} & {b}_{1 , 2} \\ {φ}_{l} {b}_{0 , 0} & - {φ}_{l} {b}_{0 , 1} & {φ}_{l} {b}_{0 , 2} & - {φ}_{l} {b}_{1 , 0} & {b}_{1 , 1} & - {b}_{1 , 2}\end{matrix} ] or$$

$${W}_{8 Tx , 6} = \frac{1}{\sqrt{12 MN}} \times [ \begin{matrix}{b}_{0} & {b}_{0} & {b}_{1} & {b}_{1} & {b}_{2} & {b}_{2} \\ {φ}_{l} {b}_{0} & - {φ}_{l} {b}_{0} & {φ}_{l} {b}_{1} & - {φ}_{l} {b}_{1} & {b}_{2} & - {b}_{2}\end{matrix} ] ;$$

rank 7 8Tx precoding matrix:

$${W}_{8 Tx , 7} = \frac{1}{\sqrt{14 MN}} \times [ \begin{matrix}{b}_{0 , 0} & {b}_{0 , 1} & {b}_{0 , 2} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & {b}_{1 , 0} & - {b}_{1 , 1} & {b}_{1 , 2} & - {b}_{1 , 3}\end{matrix} ] or$$

$${W}_{8 Tx , 7} = \frac{1}{\sqrt{14 MN}} \times [ \begin{matrix}{b}_{0} & {b}_{0} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & {b}_{2} & - {b}_{2} & {b}_{3} & - {b}_{3}\end{matrix} ] ;$$

rank 8 8Tx precoding matrix:

$${W}_{8 Tx , 8} = \frac{1}{\sqrt{16 MN}} \times [ \begin{matrix}{b}_{0 , 0} & {b}_{0 , 1} & {b}_{0 , 2} & {b}_{0 , 3} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & - {φ}_{l} {b}_{0 , 3} & {b}_{1 , 0} & - {b}_{1 , 1} & {b}_{1 , 2} & - {b}_{1 , 3}\end{matrix} ] or$$

$${W}_{8 Tx , 8} = \frac{1}{\sqrt{16 MN}} \times [ \begin{matrix}{b}_{0} & {b}_{0} & {b}_{1} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & - {φ}_{l} {b}_{1} & {b}_{2} & - {b}_{2} & {b}_{3} & - {b}_{3}\end{matrix} ] ,$$

where, each of {b₀}, {b₀, b₁}, {b₀, b₁, b₂} and {b₀, b₁, b₂, b₃} is the one 4Tx precoding matrix, each pair of {b_{0,0}, b_{0,1}} and {b_{1,0}, b_{1,1}, b_{1,2}}, {b_{0,0}, b_{0,1}, b_{0,2}} and {b_{1,0}, b_{1,1}, b_{1,2}}, {b_{0,0}, b_{0,1}, b_{0,2}} and {b_{1,0}, b_{1,1}, b_{1,2}, b_{1,3}}, and {b_{0,0}, b_{0,1}, b_{0,2}, b_{0,3}} and {b_{1,0}, b_{1,1}, b_{1,2}, b_{1,3}} is the two 4Tx precoding matrices, φₗ is the co-phasing coefficient, and M indicates the number of antennas in horizontal, and N indicates the number of antennas in vertical.

In some embodiment, the TPMI field further indicates the rank of the scheduled PUSCH transmission.

FIG. 4 is a schematic block diagram illustrating apparatuses according to one embodiment.

Referring to FIG. 4, the UE (i.e., the remote unit) includes a processor, a memory, and a transceiver. The processor implements a function, a process, and/or a method which are proposed in FIG. 2.

The UE comprises a transceiver; and a processor coupled to the transceiver, wherein the processor is configured to receive, via the transceiver, a DCI scheduling PUSCH transmission with 8 antenna ports, wherein the DCI includes a TPMI field indicating one or two 4Tx precoding matrices and a co-phasing coefficient; and determine a 8Tx precoding matrix for the scheduled PUSCH transmission according to the TPMI field.

In some embodiment, if the scheduled PUSCH transmission is rank 1 PUSCH transmission, the co-phasing coefficient is indicated as 1, j, −1 or j, and if the scheduled PUSCH transmission is rank 2, rank 3, rank 4, rank 5, rank 6, rank 7 and rank 8 PUSCH transmission, the co-phasing coefficient is indicated as 1 or j.

In some embodiment, if the scheduled PUSCH transmission is rank 1 PUSCH transmission, the one 4Tx precoding matrix is a rank 1 4Tx precoding matrix; if the scheduled PUSCH transmission is rank 2 PUSCH transmission, the one 4Tx precoding matrix is a rank 2 4Tx precoding matrix; if the scheduled PUSCH transmission is rank 3 PUSCH transmission, the one 4Tx precoding matrix is a rank 3 4Tx precoding matrix; if the scheduled PUSCH transmission is rank 4 PUSCH transmission, the one 4Tx precoding matrix is a rank 4 4Tx precoding matrix; if the scheduled PUSCH transmission is rank 5 PUSCH transmission, the one 4Tx precoding matrix is a rank 3 4Tx precoding matrix, or the two 4Tx precoding matrices are a rank 2 4Tx precoding matrix and a rank 3 4Tx precoding matrix; if the scheduled PUSCH transmission is rank 6 PUSCH transmission, the one 4Tx precoding matrix is a rank 3 4Tx precoding matrix, or the two 4Tx precoding matrices are two rank 3 4Tx precoding matrices; if the scheduled PUSCH transmission is rank 7 PUSCH transmission, the one 4Tx precoding matrix is a rank 4 4Tx precoding matrix, or the two 4Tx precoding matrices are a rank 3 4Tx precoding matrix and a rank 4 4Tx precoding matrix; and if the scheduled PUSCH transmission is rank 8 PUSCH transmission, the one 4Tx precoding matrix is a rank 4 4Tx precoding matrix, or the two 4Tx precoding matrices are two rank 4 4Tx precoding matrices.

In some embodiment, if the maximum number of PUSCH layers of the scheduled PUSCH transmission is less than or equal to 4, the length of the part for indicating the one 4Tx precoding matrix is 4 bits for fully coherent only transmission, and is 5 bits for fully and partial and non-coherent transmission, and if the maximum number of PUSCH layers of the scheduled PUSCH transmission is larger than 4, the length of the part for indicating the one 4Tx precoding matrix is 2 bits or 4 bits for fully coherent only transmission and is 3 bits for fully and partial and non-coherent transmission, or the length of the part for indicating the two 4Tx precoding matrices is 3+2 bits or 4+4 bits for fully coherent only transmission and is 5+3 bits for fully and partial and non-coherent transmission.

In some embodiment, the processor is further configured to report, via the transceiver, a maxRank=8.

In some embodiment, the 8Tx precoding matrix for each rank is:
rank 1 8Tx precoding matrix:

$${W}_{8 T x , 1} = \frac{1}{\sqrt{2 M N}} \times [ \begin{matrix}{b}_{0} \\ {φ}_{l} {b}_{0}\end{matrix} ] ;$$

rank 2 8Tx precoding matrix:

$${W}_{8 T x , 2} = \frac{1}{\sqrt{4 M N}} \times [ \begin{matrix}{b}_{0} & {b}_{1} \\ {φ}_{l} {b}_{0} & - {φ}_{l} {b}_{1}\end{matrix} ] ;$$

rank 3 8Tx precoding matrix:

$${W}_{8 T x , 3} = \frac{1}{\sqrt{6 M N}} \times [ \begin{matrix}{b}_{0} & {b}_{1} & {b}_{2} \\ {φ}_{l} {b}_{0} & {φ}_{l} {b}_{1} & - {φ}_{l} {b}_{2}\end{matrix} ] ;$$

rank 4 8Tx precoding matrix:

$${W}_{8 Tx , 4} = \frac{1}{\sqrt{8 MN}} \times [ \begin{matrix}{b}_{0} & {b}_{1} & {b}_{2} & {b}_{3} \\ {φ}_{l} {b}_{0} & {φ}_{l} {b}_{1} & - {φ}_{l} {b}_{2} & - {φ}_{l} {b}_{3}\end{matrix} ] ;$$

rank 5 8Tx precoding matrix:

$${W}_{8 Tx , 5} = \frac{1}{\sqrt{10 MN}} \times [ \begin{matrix}{b}_{0 , 0} & {b}_{0 , 1} & {b}_{1 , 0} & {b}_{1 , 1} & {b}_{1 , 2} \\ {φ}_{l} {b}_{0 , 0} & - {φ}_{l} {b}_{0 , 1} & {b}_{1 , 0} & - {b}_{1 , 1} & {b}_{1 , 2}\end{matrix} ] or$$

$${W}_{8 Tx , 5} = \frac{1}{\sqrt{10 MN}} \times [ \begin{matrix}{b}_{0} & {b}_{0} & {b}_{1} & {b}_{1} & {b}_{2} \\ {φ}_{l} {b}_{0} & - {φ}_{l} {b}_{0} & {b}_{1} & - {b}_{1} & {b}_{2}\end{matrix} ] ;$$

rank 6 8Tx precoding matrix:

$${W}_{8 Tx , 6} = \frac{1}{\sqrt{12 MN}} \times [ \begin{matrix}{b}_{0 , 0} & {b}_{0 , 1} & {b}_{0 , 2} & {b}_{1 , 0} & {b}_{1 , 1} & {b}_{1 , 2} \\ {φ}_{l} {b}_{0 , 0} & - {φ}_{l} {b}_{0 , 1} & {φ}_{l} {b}_{0 , 2} & - {φ}_{l} {b}_{1 , 0} & {b}_{1 , 1} & - {b}_{1 , 2}\end{matrix} ] or$$

$${W}_{8 Tx , 6} = \frac{1}{\sqrt{12 MN}} \times [ \begin{matrix}{b}_{0} & {b}_{0} & {b}_{1} & {b}_{1} & {b}_{2} & {b}_{2} \\ {φ}_{l} {b}_{0} & - {φ}_{l} {b}_{0} & {φ}_{l} {b}_{1} & - {φ}_{l} {b}_{1} & {b}_{2} & - {b}_{2}\end{matrix} ] ;$$

rank 7 8Tx precoding matrix:

$${W}_{8 Tx , 7} = \frac{1}{\sqrt{14 MN}} \times [ \begin{matrix}{b}_{0 , 0} & {b}_{0 , 1} & {b}_{0 , 2} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & {b}_{1 , 0} & - {b}_{1 , 1} & {b}_{1 , 2} & - {b}_{1 , 3}\end{matrix} ] or$$

$${W}_{8 Tx , 7} = \frac{1}{\sqrt{14 MN}} \times [ \begin{matrix}{b}_{0} & {b}_{0} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & {b}_{2} & - {b}_{2} & {b}_{3} & - {b}_{3}\end{matrix} ] ;$$

rank 8 8Tx precoding matrix:

$${W}_{8 Tx , 8} = \frac{1}{\sqrt{16 MN}} \times [ \begin{matrix}{b}_{0 , 0} & {b}_{0 , 1} & {b}_{0 , 2} & {b}_{0 , 3} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & - {φ}_{l} {b}_{0 , 3} & {b}_{1 , 0} & - {b}_{1 , 1} & {b}_{1 , 2} & - {b}_{1 , 3}\end{matrix} ] or$$

$${W}_{8 Tx , 8} = \frac{1}{\sqrt{16 MN}} \times [ \begin{matrix}{b}_{0} & {b}_{0} & {b}_{1} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & - {φ}_{l} {b}_{1} & {b}_{2} & - {b}_{2} & {b}_{3} & - {b}_{3}\end{matrix} ] ,$$

where, each of {b₀}, {b₀, b₁}, {b₀, b₁, b₂} and {b₀, b₁, b₂, b₃} is the one 4Tx precoding matrix, each pair of {b_{0,0}, b_{0,1}} and {b_{1,0}, b_{1,1}, b_{1,2}}, {b_{0,0}, b_{0,1}, b_{0,2}} and {b_{1,0}, b_{1,1}, b_{1,2}}, {b_{0,0}, b_{0,1}, b_{0,2}} and {b_{1,0}, b_{1,1}, b_{1,2}, b_{1,3}}, and {b_{0,0}, b_{0,1}, b_{0,2}, b_{0,3}} and {b_{1,0}, b_{1,1}, b_{1,2}, b_{1,3}} is the two 4Tx precoding matrices, φₗ is the co-phasing coefficient, and M indicates the number of antennas in horizontal, and N indicates the number of antennas in vertical.

In some embodiment, the TPMI field further indicates the rank of the scheduled PUSCH transmission.

The gNB (i.e., the base unit) includes a processor, a memory, and a transceiver. The processor implements a function, a process, and/or a method which are proposed in FIG. 3.

The base unit comprises a transceiver; and a processor coupled to the transceiver, wherein the processor is configured to transmit, via the transceiver, a DCI scheduling a PUSCH transmission with 8 antenna ports, wherein the DCI includes a TPMI field indicating one or two 4Tx precoding matrices and a co-phasing coefficient; and determine the precoding matrix for the scheduled PUSCH transmission according to the TPMI field.

In some embodiment, if the scheduled PUSCH transmission is rank 1 PUSCH transmission, the co-phasing coefficient is indicated as 1,j, −1 or j, and if the scheduled PUSCH transmission is rank 2, rank 3, rank 4, rank 5, rank 6, rank 7 and rank 8 PUSCH transmission, the co-phasing coefficient is indicated as 1 or j.

In some embodiment, if the scheduled PUSCH transmission is rank 1 PUSCH transmission, the one 4Tx precoding matrix is a rank 1 4Tx precoding matrix; if the scheduled PUSCH transmission is rank 2 PUSCH transmission, the one 4Tx precoding matrix is a rank 2 4Tx precoding matrix; if the scheduled PUSCH transmission is rank 3 PUSCH transmission, the one 4Tx precoding matrix is a rank 3 4Tx precoding matrix; if the scheduled PUSCH transmission is rank 4 PUSCH transmission, the one 4Tx precoding matrix is a rank 4 4Tx precoding matrix; if the scheduled PUSCH transmission is rank 5 PUSCH transmission, the one 4Tx precoding matrix is a rank 3 4Tx precoding matrix, or the two 4Tx precoding matrices are a rank 2 4Tx precoding matrix and a rank 3 4Tx precoding matrix; if the scheduled PUSCH transmission is rank 6 PUSCH transmission, the one 4Tx precoding matrix is a rank 3 4Tx precoding matrix, or the two 4Tx precoding matrices are two rank 3 4Tx precoding matrices; if the scheduled PUSCH transmission is rank 7 PUSCH transmission, the one 4Tx precoding matrix is a rank 4 4Tx precoding matrix, or the two 4Tx precoding matrices are a rank 3 4Tx precoding matrix and a rank 4 4Tx precoding matrix; and if the scheduled PUSCH transmission is rank 8 PUSCH transmission, the one 4Tx precoding matrix is a rank 4 4Tx precoding matrix, or the two 4Tx precoding matrices are two rank 4 4Tx precoding matrices.

In some embodiment, if the maximum number of PUSCH layers of the scheduled PUSCH transmission is less than or equal to 4, the length of the part for indicating the one 4Tx precoding matrix is 4 bits for fully coherent only transmission, and is 5 bits for fully and partial and non-coherent transmission, and if the maximum number of PUSCH layers of the scheduled PUSCH transmission is larger than 4, the length of the part for indicating the one 4Tx precoding matrix is 2 bits or 4 bits for fully coherent only transmission and is 3 bits for fully and partial and non-coherent transmission, or the length of the part for indicating the two 4Tx precoding matrices is 3+2 bits or 4+4 bits for fully coherent only transmission and is 5+3 bits for fully and partial and non-coherent transmission.

In some embodiment, the processor is further configured to receive, via the transceiver, a maxRank=8.

In some embodiment, the 8Tx precoding matrix for each rank is:
rank 1 8Tx precoding matrix:

$${W}_{8 T x , 1} = \frac{1}{\sqrt{2 M N}} \times [ \begin{matrix}{b}_{0} \\ {φ}_{l} {b}_{0}\end{matrix} ] ;$$

rank 2 8Tx precoding matrix:

$${W}_{8 T x , 2} = \frac{1}{\sqrt{4 M N}} \times [ \begin{matrix}{b}_{0} & {b}_{1} \\ {φ}_{l} {b}_{0} & - {φ}_{l} {b}_{1}\end{matrix} ] ;$$

rank 3 8Tx precoding matrix:

$${W}_{8 T x , 3} = \frac{1}{\sqrt{6 M N}} \times [ \begin{matrix}{b}_{0} & {b}_{1} & {b}_{2} \\ {φ}_{l} {b}_{0} & {φ}_{l} {b}_{1} & - {φ}_{l} {b}_{2}\end{matrix} ] ;$$

rank 4 8Tx precoding matrix:

$${W}_{8 T x , 4} = \frac{1}{\sqrt{8 M N}} \times [ \begin{matrix}{b}_{0} & {b}_{1} & {b}_{2} & {b}_{3} \\ {φ}_{l} {b}_{0} & {φ}_{l} {b}_{1} & - {φ}_{l} {b}_{2} & - {φ}_{l} {b}_{3}\end{matrix} ] ;$$

rank 5 8Tx precoding matrix:

$${W}_{8 Tx , 5} = \frac{1}{\sqrt{10 MN}} \times [ \begin{matrix}{b}_{0 , 0} & {b}_{0 , 1} & {b}_{1 , 0} & {b}_{1 , 1} & {b}_{1 , 2} \\ {φ}_{l} {b}_{0 , 0} & - {φ}_{l} {b}_{0 , 1} & {b}_{1 , 0} & - {b}_{1 , 1} & {b}_{1 , 2}\end{matrix} ] or$$

$${W}_{8 Tx , 5} = \frac{1}{\sqrt{10 MN}} \times [ \begin{matrix}{b}_{0} & {b}_{0} & {b}_{1} & {b}_{1} & {b}_{2} \\ {φ}_{l} {b}_{0} & - {φ}_{l} {b}_{0} & {b}_{1} & - {b}_{1} & {b}_{2}\end{matrix} ] ;$$

rank 6 8Tx precoding matrix:

$${W}_{8 Tx , 6} = \frac{1}{\sqrt{12 MN}} \times [ \begin{matrix}{b}_{0 , 0} & {b}_{0 , 1} & {b}_{0 , 2} & {b}_{1 , 0} & {b}_{1 , 1} & {b}_{1 , 2} \\ {φ}_{l} {b}_{0 , 0} & - {φ}_{l} {b}_{0 , 1} & {φ}_{l} {b}_{0 , 2} & - {φ}_{l} {b}_{1 , 0} & {b}_{1 , 1} & - {b}_{1 , 2}\end{matrix} ] or$$

$${W}_{8 Tx , 6} = \frac{1}{\sqrt{12 MN}} \times [ \begin{matrix}{b}_{0} & {b}_{0} & {b}_{1} & {b}_{1} & {b}_{2} & {b}_{2} \\ {φ}_{l} {b}_{0} & - {φ}_{l} {b}_{0} & {φ}_{l} {b}_{1} & - {φ}_{l} {b}_{1} & {b}_{2} & - {b}_{2}\end{matrix} ] ;$$

rank 7 8Tx precoding matrix:

$${W}_{8 Tx , 7} = \frac{1}{\sqrt{14 MN}} \times [ \begin{matrix}{b}_{0 , 0} & {b}_{0 , 1} & {b}_{0 , 2} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & {b}_{1 , 0} & - {b}_{1 , 1} & {b}_{1 , 2} & - {b}_{1 , 3}\end{matrix} ] or$$

$${W}_{8 Tx , 7} = \frac{1}{\sqrt{14 MN}} \times [ \begin{matrix}{b}_{0} & {b}_{0} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & {b}_{2} & - {b}_{2} & {b}_{3} & - {b}_{3}\end{matrix} ] ;$$

rank 8 8Tx precoding matrix:

$${W}_{8 Tx , 8} = \frac{1}{\sqrt{16 MN}} \times [ \begin{matrix}{b}_{0 , 0} & {b}_{0 , 1} & {b}_{0 , 2} & {b}_{0 , 3} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & - {φ}_{l} {b}_{0 , 3} & {b}_{1 , 0} & - {b}_{1 , 1} & {b}_{1 , 2} & - {b}_{1 , 3}\end{matrix} ] or$$

$${W}_{8 Tx , 8} = \frac{1}{\sqrt{16 MN}} \times [ \begin{matrix}{b}_{0} & {b}_{0} & {b}_{1} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & - {φ}_{l} {b}_{1} & {b}_{2} & - {b}_{2} & {b}_{3} & - {b}_{3}\end{matrix} ] ,$$

where, each of {b₀}, {b₀, b₁}, {b₀, b₁, b₂} and {b₀, b₁, b₂, b₃} is the one 4Tx precoding matrix, each pair of {b_{0,0}, b_{0,1}} and {b_{1,0}, b_{1,1}, b_{1,2}}, {b_{0,0}, b_{0,1}, b_{0,2}} and {b_{1,0}, b_{1,1}, b_{1,2}}, {b_{0,0}, b_{0,1}, b_{0,2}} and {b_{1,0}, b_{1,1}, b_{1,2}, b_{1,3}}, and {b_{0,0}, b_{0,1}, b_{0,2}, b_{0,3}} and {b_{1,0}, b_{1,1}, b_{1,2}, b_{1,3}} is the two 4Tx precoding matrices, <φₗ is the co-phasing coefficient, and M indicates the number of antennas in horizontal, and N indicates the number of antennas in vertical.

In some embodiment, the TPMI field further indicates the rank of the scheduled PUSCH transmission.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

The tables mentioned in this specification:

TABLE 1
Household base 4Tx Codebook W

| | | Number of layers v | | | |
|---|---|---|---|---|---|
| TPMI index | uₙ | 1 | 2 | 3 | 4 |
| 0 | u₀ = [1 −1 −1 −1]^{T} | ${W}_{0}^{\{ 1 \}}$ | ${W}_{0}^{\{ 14 \}}$ | ${W}_{0}^{\{ 124 \}}$ | ${W}_{0}^{\{ 1234 \}}$ |
| 1 | u₁ = [1 −j 1 j]^{T} | ${W}_{1}^{\{ 1 \}}$ | ${W}_{1}^{\{ 12 \}}$ | ${W}_{1}^{\{ 123 \}}$ | ${W}_{1}^{\{ 1234 \}}$ |
| 2 | u₂ = [1 1 −1 1]^{T} | ${W}_{2}^{\{ 1 \}}$ | ${W}_{2}^{\{ 12 \}}$ | ${W}_{2}^{\{ 123 \}}$ | ${W}_{2}^{\{ 3214 \}}$ |
| 3 | u₃ = [1 j 1 −j]^{T} | ${W}_{3}^{\{ 1 \}}$ | ${W}_{3}^{\{ 12 \}}$ | ${W}_{3}^{\{ 123 \}}$ | ${W}_{3}^{\{ 3214 \}}$ |
| 4 | u₄ = [1 (−1 −j)/\sqrt{2} −j (1 −j)/\sqrt{2}]^{T} | ${W}_{4}^{\{ 1 \}}$ | ${W}_{4}^{\{ 14 \}}$ | ${W}_{4}^{\{ 124 \}}$ | ${W}_{4}^{\{ 1234 \}}$ |
| 5 | u₅ = [1(1 − j)/\sqrt{2} j (−1 −j )/\sqrt{2}]^{T} | ${W}_{5}^{\{ 1 \}}$ | ${W}_{5}^{\{ 14 \}}$ | ${W}_{5}^{\{ 124 \}}$ | ${W}_{5}^{\{ 1234 \}}$ |
| 6 | u₆ = [1(1 + j)/\sqrt{2} − j (−1 +j )/\sqrt{2}]^{T} | ${W}_{6}^{\{ 1 \}}$ | ${W}_{6}^{\{ 13 \}}$ | ${W}_{6}^{\{ 134 \}}$ | ${W}_{6}^{\{ 1324 \}}$ |
| 7 | u₇ = [1(−1 +j )\sqrt{2} j (1 + j)/\sqrt{2}]^{T} | ${W}_{7}^{\{ 1 \}}$ | ${W}_{7}^{\{ 13 \}}$ | ${W}_{7}^{\{ 134 \}}$ | ${W}_{7}^{\{ 1324 \}}$ |
| 8 | u₈ = [1 −1 1 1]^{T} | ${W}_{8}^{\{ 1 \}}$ | ${W}_{8}^{\{ 12 \}}$ | ${W}_{8}^{\{ 124 \}}$ | ${W}_{8}^{\{ 1234 \}}$ |
| 9 | u₉ = [1 −j −1 −j]^{T} | ${W}_{9}^{\{ 1 \}}$ | ${W}_{9}^{\{ 14 \}}$ | ${W}_{9}^{\{ 134 \}}$ | ${W}_{9}^{\{ 1234 \}}$ |
| 10 | u₁₀ = [1 1 1 1]^{T} | ${W}_{10}^{\{ 1 \}}$ | ${W}_{10}^{\{ 13 \}}$ | ${W}_{10}^{\{ 123 \}}$ | ${W}_{10}^{\{ 1324 \}}$ |
| 11 | u₁₁ = [1 j −1 j]^{T} | ${W}_{11}^{\{ 1 \}}$ | ${W}_{11}^{\{ 13 \}}$ | ${W}_{11}^{\{ 134 \}}$ | ${W}_{11}^{\{ 1324 \}}$ |
| 12 | u₁₂ = [1 −1 −1 1]]^{T} | ${W}_{12}^{\{ 1 \}}$ | ${W}_{12}^{\{ 12 \}}$ | ${W}_{12}^{\{ 123 \}}$ | ${W}_{12}^{\{ 1234 \}}$ |
| 13 | u₁₃ = [1 −1 1 −1]^{T} | ${W}_{13}^{\{ 1 \}}$ | ${W}_{13}^{\{ 13 \}}$ | ${W}_{13}^{\{ 123 \}}$ | ${W}_{13}^{\{ 1324 \}}$ |
| 14 | u₁₄ = [1 1 −1 −1]^{T} | ${W}_{14}^{\{ 1 \}}$ | ${W}_{14}^{\{ 13 \}}$ | ${W}_{14}^{\{ 123 \}}$ | ${W}_{14}^{\{ 3214 \}}$ |
| 15 | u₁₅ = [1 1 1 1]^{T} | ${W}_{15}^{\{ 1 \}}$ | ${W}_{15}^{\{ 12 \}}$ | ${W}_{15}^{\{ 123 \}}$ | ${W}_{15}^{\{ 1234 \}}$ |
| | | the 3^{rd} | the 4^{th} | the 5^{th} | the 6^{th} |
| | | column | column | column | column |

Note:
$The quantity {W}_{n}^{\{ s \}} denotes the matrix defined by the columns given by the set \{ s \} from the$ $expression {W}_{0} = I - 2 {u}_{n} {u}_{n}^{H} / {u}_{n}^{H} {u}_{n} where I is the 4 \times 4 identity matrix and the vector . For example ,$ ${W}_{0}^{\{ 1 \}} refers to a matrix defined by the first column of {W}_{0} = I - 2 {u}_{0} {u}_{0}^{H} / {u}_{0}^{H} {u}_{0} ; {W}_{0}^{\{ 14 \}} refers to a matrix$ $defined by the first and the fourth columns of {W}_{0} ; {W}_{0}^{\{ 124 \}} refers to a matrix defined by the first , the$ $second and the fourth columns of {W}_{0} ; and {W}_{0}^{\{ 1234 \}} refers to a matrix defined by the first , the$ second, the third and the fourth columns of W₀ (i.e., the same as W₀).

TABLE 2
Precoding matrix W for rank 1 transmission with DFT-s-OFDM waveform

| | W | | | | | | | |
|---|---|---|---|---|---|---|---|---|
| TPMI index | (ordered from left to right in increasing order of TPMI index) | | | | | | | |
| 0-7 | $[ \begin{matrix}1 \\ 1 \\ 1 \\ - 1\end{matrix} ]$ | $[ \begin{matrix}1 \\ 1 \\ j \\ j\end{matrix} ]$ | $[ \begin{matrix}1 \\ 1 \\ - 1 \\ 1\end{matrix} ]$ | $[ \begin{matrix}1 \\ 1 \\ - j \\ - j\end{matrix} ]$ | $[ \begin{matrix}1 \\ j \\ 1 \\ j\end{matrix} ]$ | $[ \begin{matrix}1 \\ j \\ j \\ 1\end{matrix} ]$ | $[ \begin{matrix}1 \\ j \\ - 1 \\ - j\end{matrix} ]$ | $[ \begin{matrix}1 \\ j \\ - j \\ - 1\end{matrix} ]$ |
| 8-15 | $[ \begin{matrix}1 \\ - 1 \\ 1 \\ 1\end{matrix} ]$ | $[ \begin{matrix}1 \\ - 1 \\ j \\ - j\end{matrix} ]$ | $[ \begin{matrix}1 \\ - 1 \\ - 1 \\ - 1\end{matrix} ]$ | $[ \begin{matrix}1 \\ - 1 \\ - j \\ j\end{matrix} ]$ | $[ \begin{matrix}1 \\ - j \\ 1 \\ - j\end{matrix} ]$ | $[ \begin{matrix}1 \\ - j \\ j \\ - 1\end{matrix} ]$ | $[ \begin{matrix}1 \\ - j \\ - 1 \\ j\end{matrix} ]$ | $[ \begin{matrix}1 \\ - j \\ - j \\ 1\end{matrix} ]$ |

TABLE 3
Precoding matrix W for rank 1 transmission with CP-OFDM waveform

| | W | | | | | | | |
|---|---|---|---|---|---|---|---|---|
| TPMI index | (ordered from left to right in increasing order of TPMI index) | | | | | | | |
| 0-7 | $[ \begin{matrix}1 \\ 1 \\ 1 \\ 1\end{matrix} ]$ | $[ \begin{matrix}1 \\ 1 \\ j \\ j\end{matrix} ]$ | $[ \begin{matrix}1 \\ 1 \\ - 1 \\ - 1\end{matrix} ]$ | $[ \begin{matrix}1 \\ 1 \\ - j \\ - j\end{matrix} ]$ | $[ \begin{matrix}1 \\ j \\ 1 \\ j\end{matrix} ]$ | $[ \begin{matrix}1 \\ j \\ j \\ - 1\end{matrix} ]$ | $[ \begin{matrix}1 \\ j \\ - 1 \\ - j\end{matrix} ]$ | $[ \begin{matrix}1 \\ j \\ - j \\ 1\end{matrix} ]$ |
| 8-15 | $[ \begin{matrix}1 \\ - 1 \\ 1 \\ - 1\end{matrix} ]$ | $[ \begin{matrix}1 \\ - 1 \\ j \\ - j\end{matrix} ]$ | $[ \begin{matrix}1 \\ - 1 \\ - 1 \\ 1\end{matrix} ]$ | $[ \begin{matrix}1 \\ - 1 \\ - j \\ j\end{matrix} ]$ | $[ \begin{matrix}1 \\ - j \\ 1 \\ - j\end{matrix} ]$ | $[ \begin{matrix}1 \\ - j \\ j \\ 1\end{matrix} ]$ | $[ \begin{matrix}1 \\ - j \\ - 1 \\ j\end{matrix} ]$ | $[ \begin{matrix}1 \\ - j \\ - j \\ - 1\end{matrix} ]$ |

TABLE 4
Precoding matrix W for rank 2 transmission with CP-OFDM waveform

| TPMI | W | | | | | | | |
|---|---|---|---|---|---|---|---|---|
| index | (ordered from left to right in increasing order of TPMI index) | | | | | | | |
| 0-7 | $[ \begin{matrix}1 & 1 \\ 1 & 1 \\ 1 & - 1 \\ 1 & - 1\end{matrix} ]$ | $[ \begin{matrix}1 & 1 \\ 1 & 1 \\ j & - j \\ j & - j\end{matrix} ]$ | $[ \begin{matrix}1 & 1 \\ j & j \\ 1 & - 1 \\ j & - j\end{matrix} ]$ | $[ \begin{matrix}1 & 1 \\ j & j \\ j & - j \\ - 1 & 1\end{matrix} ]$ | $[ \begin{matrix}1 & 1 \\ - 1 & - 1 \\ 1 & - 1 \\ - 1 & 1\end{matrix} ]$ | $[ \begin{matrix}1 & 1 \\ - 1 & - 1 \\ j & - j \\ - j & j\end{matrix} ]$ | $[ \begin{matrix}1 & 1 \\ - j & - j \\ 1 & - 1 \\ - j & j\end{matrix} ]$ | $[ \begin{matrix}1 & 1 \\ - j & - j \\ j & - j \\ 1 & - 1\end{matrix} ]$ |

TABLE 5
Precoding matrix W for rank 3 transmission with CP-OFDM waveform

| TPMI | W | | | |
|---|---|---|---|---|
| index | (ordered from left to right in increasing order of TPMI index) | | | |
| 0-3 | $[ \begin{matrix}1 & 1 & 1 \\ 1 & - 1 & 1 \\ 1 & 1 & - 1 \\ 1 & - 1 & - 1\end{matrix} ]$ | $[ \begin{matrix}1 & 1 & 1 \\ 1 & - 1 & 1 \\ j & j & - j \\ j & - j & - j\end{matrix} ]$ | $[ \begin{matrix}1 & 1 & 1 \\ - 1 & 1 & - 1 \\ 1 & 1 & - 1 \\ - 1 & 1 & 1\end{matrix} ]$ | $[ \begin{matrix}1 & 1 & 1 \\ - 1 & 1 & - 1 \\ j & j & - j \\ - j & j & j\end{matrix} ]$ |

TABLE 6
Precoding matrix W for rank 4 transmission with
CP-OFDM waveform

| | |
|---|---|
| TPMI | W |
| index | (ordered from left to right in increasing order of TPMI index) |

| | | |
|---|---|---|
| 0-1 | $[ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ | $[ \begin{matrix}1 & 1 & 1 & 1 \\ 1 & - 1 & 1 & - 1 \\ j & j & - j & - j \\ j & - j & - j & j\end{matrix} ]$ |

TABLE 7
TPMI field overhead

| | Rank = 1 | Rank = 2 | Rank = 3 | Rank = 4 |
|---|---|---|---|---|
| Scheme 1, fully | log₂(16) + log₂(4) = | log₂(8) + log₂(2) = | log₂(4) + log₂(2) = | log₂(2) + log₂(2) = |
| coherent only | 4 + 2 = 6 bits | 3 + 1 = 4 bits | 2 + 1 = 3 bits | 1 + 1 = 2 bits |
| transmission | | | | |
| Scheme 1, fully | [log₂(28)] + log₂(4) = | [log₂(22)] + log₂(2) = | [log₂(7)] + log₂(2) = | [log₂(5)] + log₂(2) = |
| and partial and | 5 + 2 = 7 bits | 5 + 1 = 6 bits | 3 + 1 = 4 bits | 3 + 1 = 4 bits |
| non-coherent | | | | |
| transmission | | | | |
| Scheme 2 (fully | log₂(16) + log₂(4) = | log₂(16) + log₂(2) = | log₂(16) + log₂(2) = | log₂(16) + log₂(2) = |
| coherent only | 4 + 2 = 6 bits | 4 + 1 = 5 bits | 4 + 1 = 5 bits | 4 + 1 = 5 bits |
| transmission) | | | | |

TABLE 8
Joint precoding matrix, co-phasing coefficient and transmit rank indicated
for ″Scheme 1, fully coherent only transmission″ with maxRank = 4

| ‘index of transmit | | |
|---|---|---|
| precoding matrix | | |
| and rank’ field | | |
| mapped to index | Indicated precoding matirx | Note |
| 0 | 1 layer: TPMI = 0, l = 0 | Matrix for each |
| 1 | 1 layer: TPMI = 0, l = 1 | TPMI corresponds to |
| 2 | 1 layer: TPMI = 0, l = 2 | Table 2 or Table 3 |
| 3 | 1 layer: TPMI = 0, l = 3 | without coefficient |
| 4 | 1 layer: TPMI = 1, l = 0 | |
| . . . | . . . | |
| 63 | 1 layer: TPMI = 15, l = 3 | |
| 64 | 2 layers: TPMI = 0, l = 0 | Matrix for each |
| 65 | 2 layers: TPMI = 0, l = 1 | TPMI corresponds to |
| 66 | 2 layers: TPMI = 1, l = 0 | Table 4 without |
| . . . | . . . | coefficient Table |
| 79 | 2 layers: TPMI = 7, l = 1 | |
| 80 | 3 layers: TPMI = 0, l = 0 | Matrix for each |
| 81 | 3 layers: TPMI = 0, l = 1 | TPMI corresponds to |
| 82 | 3 layers: TPMI = 1, l = 0 | Table 5 without |
| . . . | . . . | coefficient |
| 87 | 3 layers: TPMI = 3, l = 1 | |
| 88 | 4 layers: TPMI = 0, l = 0 | Matrix for each |
| 89 | 4 layers: TPMI = 0, l = 1 | TPMI corresponds to |
| 90 | 4 layers: TPMI = 1, l = 0 | Table 6 without |
| 91 | 4 layers: TPMI = 1, l = 1 | coefficient |

TABLE 9
Joint precoding matrix, co-phasing coefficient and transmit rank indicated
for “Scheme 2 (fully coherent only transmission)” with maxRank = 4

| ‘index of transmit | | |
|---|---|---|
| precoding matrix | | |
| and rank’ field | | |
| mapped to index | Indicated precoding matirx | Note |
| 0 | 1 layer: TPMI = 0, l = 0 | Matrix for each |
| 1 | 1 layer: TPMI = 0, l = 1 | TPMI corresponds to |
| 2 | 1 layer: TPMI = 0, l = 2 | the 3^{rd} column of |
| 3 | 1 layer: TPMI = 0, l = 3 | Table 1. |
| 4 | 1 layer: TPMI = 1, l = 0 | |
| . . . | . . . | |
| 63 | 1 layer: TPMI = 15, l = 3 | |
| 64 | 2 layers: TPMI = 0, l = 0 | Matrix for each |
| 65 | 2 layers: TPMI = 0, l = 1 | TPMI corresponds to |
| 66 | 2 layers: TPMI = 1, l = 0 | the 4^{th} column of |
| . . . | . . . | Table 1. |
| 95 | 2 layers: TPMI = 15, l = 1 | |
| 96 | 3 layers: TPMI = 0, l = 0 | Matrix for each |
| 97 | 3 layers: TPMI = 0, l = 1 | TPMI corresponds to |
| 98 | 3 layers: TPMI = 1, l = 0 | the 5^{th} column of |
| . . . | . . . | Table 1. |
| 127 | 3 layers: TPMI = 15, l = 1 | |
| 128 | 4 layers: TPMI = 0, l = 0 | Matrix for each |
| 129 | 4 layers: TPMI = 0, l = 1 | TPMI corresponds to |
| 130 | 4 layers: TPMI = 1, l = 0 | the 6^{th} column of |
| | | Table 1. |
| 159 | 4 layers: TPMI = 15, l = 1 | |

TABLE 10
TPMI field contents for different schemes

| | Scheme 1 | | |
|---|---|---|---|
| | | Fully and Partial and Non- | |
| | Fully coherent only | coherent | Scheme 2 |
| Rank 1 | W(4 bits) + φ(2 bits) | W(5 bits) + φ(2 bits) | W(4 bits) + φ(2 bits) |
| Rank 2 | W(3 bits) + φ(1 bit) | W(5 bits) + φ(1 bit) | W(4 bits) + φ(1 bit) |
| Rank 3 | W(2 bits) + φ(1 bit) | W(3 bits) + φ(1 bit) | W(4 bits) + φ(1 bit) |
| Rank 4 | W(1 bit) + φ(1 bit) | W(3 bits) + φ(1 bit) | W(4 bits) + φ(1 bit) |
| Rank | W(4 bits) + φ(2 bits) | W(5 bits) + φ(2 bits) | W(4 bits) + φ(2 bits) |
| 1/2/3/4 | | | |
| Rank 5 | W_{5.1} (3 bits) + W_{5.2} (2 | W_{5.1} (5 bits) + W_{5.2} (3 bits) + | W_{5.1} (4 bits) + W_{5.2} (4 bits) + |
| | bits) + φ(1 bit) | φ(1 bit) | φ(1 bit) |
| Rank 6 | W_{6.1} (2 bits) + W_{6.2} (2 | W_{6.1} (3 bits) + W_{6.2} (3 bits) + | W_{6.1} (4 bits) + W_{6.2} (4 bits) + |
| | bits) + φ(1 bit) | φ(1 bit) | φ(1 bit) |
| Rank 7 | W_{7.1} (2 bits) + W_{7.2} (1 bit) + | W_{7.1} (3 bits) + W_{7.2} (3 bits) + | W_{7.1} (4 bits) + W_{7.2} (4 bits) + |
| | φ(1 bit) | φ(1 bit) | φ(1 bit) |
| Rank 8 | W_{8.1} (1 bit) + W_{8.2} (1 bit) + | W_{8.1} (3 bits) + W_{8.2} (3 bits) + | W_{8.1} (4 bits) + W_{8.2} (4 bits) + |
| | φ(1 bit) | φ(1 bit) | φ(1 bit) |
| Rank | W_{ri.1}(3 bits) + W_{ri.2}(2 | W_{ri.1}(5 bits) + W_{ri.2}(3 bits) + | W_{ri.1}(4 bits) + W_{ri.2}(4 bits) + |
| 5/6/7/8 | bits) + φ(1 bit) | φ(1 bit) | φ(1 bit) |

TABLE 11
TPMI field contents for different schemes

| | Scheme 1 | | |
|---|---|---|---|
| | | Fully and Partial and | |
| | Fully coherent only | Non-coherent | Scheme 2 |
| Rank 5 | W₅ (2 bits) + φ(1 bit) | W₅ (3 bits) + φ(1 bit) | W₅ (4 bits) + φ(1 bit) |
| Rank 6 | W₆ (2 bits) + φ(1 bit) | W₆ (3 bits) + φ(1 bit) | W₆ (4 bits) + φ(1 bit) |
| Rank 7 | W₇ (1 bit) + φ(1 bit) | W₇ (3 bits) + φ(1 bit) | W₇ (4 bits) + φ(1 bit) |
| Rank 8 | W₈ (1 bit) + φ(1 bit) | W₈ (3 bits) + φ(1 bit) | W₈ (4 bits) + φ(1 bit) |
| Rank | W (2 bits) + φ(1 bit) | W (3 bits) + φ(1 bit) | W (4 bits) + φ(1 bit) |
| 5/6/7/8 | | | |

TABLE 6.3.1.5-2
Precoding matrix W for single-layer transmission using four antenna ports with
transform precoding enabled.

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - j \\ 1\end{matrix} ]$ | — | — | — | — |

TABLE 6.3.1.5-3
Precoding matrix W for single-layer transmission using four antenna ports with
transform precoding disabled.

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 6.3.1.5-5
Precoding matrix W for two-layer transmission using four antenna ports with
transform precoding disabled.

| | W | | | |
|---|---|---|---|---|
| TPMI index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 6.3.1.5-6
Precoding matrix W for three-layer transmission using four antenna ports with
transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 6.3.1.5-7
Precoding matrix W for four-layer transmission using four antenna ports with
transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

What is claimed is:

1. A user equipment (UE) for wireless communication, comprising:
at least one memory; and
at least one processor coupled with the at least one memory and operable to cause the UE to:
receive a downlink control information (DCI) scheduling physical uplink shared channel (PUSCH) transmission with 8 antenna ports, wherein the DCI includes a transmit precoding matrix indicator (TPMI) field indicating at least one 4Tx precoding matrix or two 4Tx precoding matrices and a co-phasing coefficient; and
determine a 8Tx precoding matrix for the scheduled PUSCH transmission according to the TPMI field.

2. The UE of claim 1, wherein:
if the scheduled PUSCH transmission is a rank 1 PUSCH transmission, the co-phasing coefficient is indicated as 1, j, −1 or −j, and
if the scheduled PUSCH transmission is a rank 2 PUSCH transmission, a rank 3 PUSCH transmission a rank 4 PUSCH transmission, a rank 5 PUSCH transmission, a rank 6 PUSCH transmission a rank 7 PUSCH transmission, or a rank 8 PUSCH transmission, the co-phasing coefficient is indicated as 1 or j.

3. The UE of claim 1, wherein:
if the scheduled PUSCH transmission is a rank 1 PUSCH transmission, the one 4Tx precoding matrix is a rank 1 4Tx precoding matrix;
if the scheduled PUSCH transmission is a rank 2 PUSCH transmission, the one 4Tx precoding matrix is a rank 2 4Tx precoding matrix;
if the scheduled PUSCH transmission is a rank 3 PUSCH transmission, the one 4Tx precoding matrix is a rank 3 4Tx precoding matrix;
if the scheduled PUSCH transmission is a rank 4 PUSCH transmission, the one 4Tx precoding matrix is a rank 4 4Tx precoding matrix;
if the scheduled PUSCH transmission is a rank 5 PUSCH transmission, the one 4Tx precoding matrix is a rank 3 4Tx precoding matrix, or the two 4Tx precoding matrices are a rank 2 4Tx precoding matrix and a rank 3 4Tx precoding matrix;
if the scheduled PUSCH transmission is a rank 6 PUSCH transmission, the one 4Tx precoding matrix is a rank 3 4Tx precoding matrix, or the two 4Tx precoding matrices are two rank 3 4Tx precoding matrices;
if the scheduled PUSCH transmission is a rank 7 PUSCH transmission, the one 4Tx precoding matrix is a rank 4 4Tx precoding matrix, or the two 4Tx precoding matrices are a rank 3 4Tx precoding matrix and a rank 4 4Tx precoding matrix; and
if the scheduled PUSCH transmission is a rank 8 PUSCH transmission, the one 4Tx precoding matrix is a rank 4 4Tx precoding matrix, or the two 4Tx precoding matrices are two rank 4 4Tx precoding matrices.

4. The UE of claim 1, wherein:
if a maximum number of PUSCH layers of the scheduled PUSCH transmission is less than or equal to 4, a length of a part of the TPMI field for indicating the one 4Tx precoding matrix is 4 bits for fully coherent only transmission, and is 5 bits for fully and partial and non-coherent transmission; and
if the maximum number of PUSCH layers of the scheduled PUSCH transmission is larger than 4, the length of the part of the TPMI field for indicating the one 4Tx precoding matrix is 2 bits or 4 bits for fully coherent only transmission and is 3 bits for fully and partial and non-coherent transmission, or a length of a part of the TPMI field for indicating the two 4Tx precoding matrices is 3+2 bits or 4+4 bits for fully coherent only transmission and is 5+3 bits for fully and partial and non-coherent transmission.

5. The UE of claim 1, wherein the at least one processor is operable to cause the UE to report a maxRank=8.

6. The UE of claim 1, wherein, the 8Tx precoding matrix for each rank is:
rank 1 8Tx precoding matrix:
$${W}_{8 T x , 1} = \frac{1}{\sqrt{2 M N}} \times [ \begin{matrix}{b}_{0} \\ {φ}_{l} {b}_{0}\end{matrix} ] ;$$
rank 2 8Tx precoding matrix:
$${W}_{8 T x , 2} = \frac{1}{\sqrt{4 MN}} \times [ \begin{matrix}{b}_{0} & {b}_{1} \\ {φ}_{l} {b}_{0} & - {φ}_{l} {b}_{1}\end{matrix} ] ;$$
rank 3 8Tx precoding matrix:
$${W}_{8 T x , 3} = \frac{1}{\sqrt{6 MN}} \times [ \begin{matrix}{b}_{0} & {b}_{1} & {b}_{2} \\ {φ}_{l} {b}_{0} & {φ}_{l} {b}_{1} & - {φ}_{l} {b}_{2}\end{matrix} ] ;$$
rank 4 8Tx precoding matrix:
$${W}_{8 T x , 4} = \frac{1}{\sqrt{8 MN}} \times [ \begin{matrix}{b}_{0} & {b}_{1} & {b}_{2} & {b}_{3} \\ {φ}_{l} {b}_{0} & {φ}_{l} {b}_{1} & - {φ}_{l} {b}_{2} & - {φ}_{l} {b}_{3}\end{matrix} ] ;$$
rank 5 8Tx precoding matrix:
$${W}_{8 T x , 5} = \frac{1}{\sqrt{10 MN}} \times [ \begin{matrix}{b}_{0 , 0} & {b}_{0 , 1} & {b}_{1 , 0} & {b}_{1 , 1} & {b}_{1 , 2} \\ {φ}_{l} {b}_{0 , 0} & - {φ}_{l} {b}_{0 , 1} & {b}_{1 , 0} & - {b}_{1 , 1} & {b}_{1 , 2}\end{matrix} ]$$
$$or$$
$${W}_{8 T x , 5} = \frac{1}{\sqrt{10 MN}} \times [ \begin{matrix}{b}_{0} & {b}_{0} & {b}_{1} & {b}_{1} & {b}_{2} \\ {φ}_{l} {b}_{0} & - {φ}_{l} {b}_{0} & {b}_{1} & - {b}_{1} & {b}_{2}\end{matrix} ] ;$$
rank 6 8Tx precoding matrix:
$${W}_{8 T x , 6} = \frac{1}{\sqrt{12 MN}} \times [ \begin{matrix}{b}_{0 , 0} & {b}_{0 , 1} & {b}_{0 , 2} & {b}_{1 , 0} & {b}_{1 , 1} & {b}_{1 , 2} \\ {φ}_{l} {b}_{0 , 0} & - {φ}_{l} {b}_{0 , 1} & {φ}_{l} {b}_{0 , 2} & - {φ}_{l} {b}_{1 , 0} & {b}_{1 , 1} & - {b}_{1 , 2}\end{matrix} ]$$
$$or$$
$${W}_{8 T x , 6} = \frac{1}{\sqrt{12 MN}} \times [ \begin{matrix}{b}_{0} & {b}_{0} & {b}_{1} & {b}_{1} & {b}_{2} & {b}_{2} \\ {φ}_{l} {b}_{0} & - {φ}_{l} {b}_{0} & {φ}_{l} {b}_{1} & - {φ}_{l} {b}_{1} & {b}_{2} & - {b}_{2}\end{matrix} ] ;$$
rank 7 8Tx precoding matrix:
$${W}_{8 T x , 7} = \frac{1}{\sqrt{14 MN}} \times [ \begin{matrix}{b}_{0 , 0} & {b}_{0 , 1} & {b}_{0 , 2} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & {b}_{1 , 0} & - {b}_{1 , 1} & {b}_{1 , 2} & - {b}_{1 , 3}\end{matrix} ]$$
$$or$$
$${W}_{8 T x , 7} = \frac{1}{\sqrt{14 MN}} \times [ \begin{matrix}{b}_{0} & {b}_{0} & {b}_{1} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & - {φ}_{l} {b}_{1} & {b}_{2} & - {b}_{2} & {b}_{3} & - {b}_{3}\end{matrix} ] ;$$
rank 8 8Tx precoding matrix:
$${W}_{8 T x , 8} = \frac{1}{\sqrt{16 MN}} \times [ \begin{matrix}{b}_{0 , 0} & {b}_{0 , 1} & {b}_{0 , 2} & {b}_{0 , 3} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & - {φ}_{l} {b}_{0 , 3} & {b}_{1 , 0} & - {b}_{1 , 1} & {b}_{1 , 2} & - {b}_{1 , 3}\end{matrix} ]$$
$$or$$
$${W}_{8 T x , 8} = \frac{1}{\sqrt{16 MN}} \times [ \begin{matrix}{b}_{0} & {b}_{0} & {b}_{1} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & - {φ}_{l} {b}_{1} & {b}_{2} & - {b}_{2} & {b}_{3} & - {b}_{3}\end{matrix} ] ,$$
where,
each of {b₀}, {b₀, b₁}, {b₀, b₁, b₂} and {b₀, b₁, b₂, b₃} is the one 4Tx precoding matrix,
each pair of {b_{0,0}, b_{0,1}} and {b_{1,0}, b_{1,1}, b_{1,2}}, {b_{0,0}, b_{0,1}, b_{0,2}} and {b_{1,0}, b_{1,1}, b_{1,2}}, {b_{0,0}, b_{0,1}, b_{0,2}} and {b_{1,0}, b_{1,1}, b_{1,2}, b_{1,3}}, and {b_{0,0}, b_{0,1}, b_{0,2}, b_{0,3}} and {b_{1,0}, b_{1,1}, b_{1,2}, b_{1,3}} is the two 4Tx precoding matrices,
φₗ is the co-phasing coefficient, and
M indicates a number of antennas in horizontal, and N indicates a number of antennas in vertical.

7. The UE of claim 1, wherein the TPMI field further indicates a rank of the scheduled PUSCH transmission.

8. A method performed by a user equipment (UE), the method comprising:
receiving a downlink control information (DCI) scheduling physical uplink shared channel (PUSCH) transmission with 8 antenna ports, wherein the DCI includes a transmit precoding matrix indicator (TPMI) field indicating at least one 4Tx precoding matrix or two 4Tx precoding matrices and a co-phasing coefficient; and
determining a 8Tx precoding matrix for the scheduled PUSCH transmission according to the TPMI field.

9. A base unit for wireless communication, comprising:
at least one memory; and
at least one processor coupled with the at least one memory and configured to cause the base unit to:
transmit a downlink control information (DCI) scheduling a physical uplink shared channel (PUSCH) transmission with 8 antenna ports, wherein the DCI includes a transmit precoding matrix indicator (TPMI) field indicating a least one 4 Tx precoding matrix or two 4Tx precoding matrices and a co-phasing coefficient; and
determine a precoding matrix for the scheduled PUSCH transmission according to the TPMI field.

10. The base unit of claim 9, wherein:
if the scheduled PUSCH transmission is rank 1 PUSCH transmission, the co-phasing coefficient is indicated as 1, j, −1 or −j, and
if the scheduled PUSCH transmission is a rank 2 PUSCH transmission, a rank 3 PUSCH transmission, a rank 4 PUSCH transmission, a rank 5 PUSCH transmission a rank 6 PUSCH transmission a rank 7 PUSCH transmission, or a rank 8 PUSCH transmission, the co-phasing coefficient is indicated as i or j.

11. The base unit of claim 9, wherein,
if the scheduled PUSCH transmission is a rank 1 PUSCH transmission, the one 4Tx precoding matrix is a rank 1 4Tx precoding matrix;
if the scheduled PUSCH transmission is a rank 2 PUSCH transmission, the one 4Tx precoding matrix is a rank 2 4Tx precoding matrix;
if the scheduled PUSCH transmission is a rank 3 PUSCH transmission, the one 4Tx precoding matrix is a rank 3 4Tx precoding matrix;
if the scheduled PUSCH transmission is a rank 4 PUSCH transmission, the one 4Tx precoding matrix is a rank 4 4Tx precoding matrix;
if the scheduled PUSCH transmission is a rank 5 PUSCH transmission, the one 4Tx precoding matrix is a rank 3 4Tx precoding matrix, or the two 4Tx precoding matrices are a rank 2 4Tx precoding matrix and a rank 3 4Tx precoding matrix;
if the scheduled PUSCH transmission is a rank 6 PUSCH transmission, the one 4Tx precoding matrix is a rank 3 4Tx precoding matrix, or the two 4Tx precoding matrices are two rank 3 4Tx precoding matrices;
if the scheduled PUSCH transmission is a rank 7 PUSCH transmission, the one 4Tx precoding matrix is a rank 4 4Tx precoding matrix, or the two 4Tx precoding matrices are a rank 3 4Tx precoding matrix and a rank 4 4Tx precoding matrix; and
if the scheduled PUSCH transmission is a rank 8 PUSCH transmission, the one 4Tx precoding matrix is a rank 4 4Tx precoding matrix, or the two 4Tx precoding matrices are two rank 4 4Tx precoding matrices.

12. The base unit of claim 9, wherein:
if a maximum number of PUSCH layers of the scheduled PUSCH transmission is less than or equal to 4, a length of a part of the TPMI field for indicating the one 4Tx precoding matrix is 4 bits for fully coherent only transmission, and is 5 bits for fully and partial and non-coherent transmission,
if the maximum number of PUSCH layers of the scheduled PUSCH transmission is larger than 4, the length of the part of the TPMI field for indicating the one 4Tx precoding matrix is 2 bits or 4 bits for fully coherent only transmission and is 3 bits for fully and partial and non-coherent transmission, or the length of a part of the TPMI field for indicating the two 4Tx precoding matrices is 3+2 bits or 4+4 bits for fully coherent only transmission and is 5+3 bits for fully and partial and non-coherent transmission.

13. The base unit of claim 9, wherein the at least one processor is operable to cause the base unit to receive a maxRank=8.

14. The base unit of claim 9, wherein a 8Tx precoding matrix for each rank is:
rank 1 8Tx precoding matrix:
$${W}_{8 T x , 1} = \frac{1}{\sqrt{2 MN}} \times [ \begin{matrix}{b}_{0} \\ {φ}_{l} {b}_{0}\end{matrix} ] ;$$
rank 2 8Tx precoding matrix:
$${W}_{8 T x , 2} = \frac{1}{\sqrt{4 MN}} \times [ \begin{matrix}{b}_{0} & {b}_{1} \\ {φ}_{l} {b}_{0} & - {φ}_{l} {b}_{1}\end{matrix} ] ;$$
rank 3 8Tx precoding matrix:
$${W}_{8 T x , 3} = \frac{1}{\sqrt{6 MN}} \times [ \begin{matrix}{b}_{0} & {b}_{1} & {b}_{2} \\ {φ}_{l} {b}_{0} & {φ}_{l} {b}_{1} & - {φ}_{l} {b}_{2}\end{matrix} ]$$
rank 4 8Tx precoding matrix:
$${W}_{8 T x , 4} = \frac{1}{\sqrt{8 MN}} \times [ \begin{matrix}{b}_{0} & {b}_{1} & {b}_{2} & {b}_{3} \\ {φ}_{l} {b}_{0} & {φ}_{l} {b}_{1} & - {φ}_{l} {b}_{2} & - {φ}_{l} {b}_{3}\end{matrix} ]$$
rank 5 8Tx precoding matrix:
$${W}_{8 T x , 5} = \frac{1}{\sqrt{10 MN}} \times [ \begin{matrix}{b}_{0 , 0} & {b}_{0 , 1} & {b}_{1 , 0} & {b}_{1 , 1} & {b}_{1 , 2} \\ {φ}_{l} {b}_{0 , 0} & - {φ}_{l} {b}_{0 , 1} & {b}_{1 , 0} & - {b}_{1 , 1} & {b}_{1 , 2}\end{matrix} ]$$
$$or$$
$${W}_{8 T x , 5} = \frac{1}{\sqrt{10 MN}} \times [ \begin{matrix}{b}_{0} & {b}_{0} & {b}_{1} & {b}_{1} & {b}_{2} \\ {φ}_{l} {b}_{0} & - {φ}_{l} {b}_{0} & {b}_{1} & - {b}_{1} & {b}_{2}\end{matrix} ]$$
rank 6 8Tx precoding matrix:
$${W}_{8 T x , 6} = \frac{1}{\sqrt{12 MN}} \times [ \begin{matrix}{b}_{0 , 0} & {b}_{0 , 1} & {b}_{0 , 2} & {b}_{1 , 0} & {b}_{1 , 1} & {b}_{1 , 2} \\ {φ}_{l} {b}_{0 , 0} & - {φ}_{l} {b}_{0 , 1} & {φ}_{l} {b}_{0 , 2} & - {φ}_{l} {b}_{1 , 0} & {b}_{1 , 1} & - {b}_{1 , 2}\end{matrix} ]$$
$$or$$
$${W}_{8 T x , 6} = \frac{1}{\sqrt{12 MN}} \times [ \begin{matrix}{b}_{0} & {b}_{0} & {b}_{1} & {b}_{1} & {b}_{2} & {b}_{2} \\ {φ}_{l} {b}_{0} & - {φ}_{l} {b}_{0} & {φ}_{l} {b}_{1} & - {φ}_{l} {b}_{1} & {b}_{2} & - {b}_{2}\end{matrix} ]$$
rank 7 8Tx precoding matrix:
$${W}_{8 T x , 7} = \frac{1}{\sqrt{14 MN}} \times [ \begin{matrix}{b}_{0 , 0} & {b}_{0 , 1} & {b}_{0 , 2} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & {b}_{1 , 0} & - {b}_{1 , 1} & {b}_{1 , 2} & - {b}_{1 , 3}\end{matrix} ]$$
$$or$$
$${W}_{8 T x , 7} = \frac{1}{\sqrt{14 MN}} \times [ \begin{matrix}{b}_{0} & {b}_{0} & {b}_{1} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & - {φ}_{l} {b}_{1} & {b}_{2} & - {b}_{2} & {b}_{3} & - {b}_{3}\end{matrix} ]$$
rank 8 8Tx precoding matrix:
$${W}_{8 T x , 8} = \frac{1}{\sqrt{16 MN}} \times [ \begin{matrix}{b}_{0 , 0} & {b}_{0 , 1} & {b}_{0 , 2} & {b}_{0 , 3} & {b}_{1 , 0} & {b}_{1 , 1} & {b}_{1 , 2} & {b}_{1 , 3} \\ {φ}_{l} {b}_{0 , 0} & - {φ}_{l} {b}_{0 , 1} & {φ}_{l} {b}_{0 , 2} & - {φ}_{l} {b}_{0 , 3} & {b}_{1 , 0} & - {b}_{1 , 1} & {b}_{1 , 2} & - {b}_{1 , 3}\end{matrix} ]$$
$$or$$
$${W}_{8 T x , 8} = \frac{1}{\sqrt{16 MN}} \times [ \begin{matrix}{b}_{0} & {b}_{0} & {b}_{1} & {b}_{1} & {b}_{2} & {b}_{2} & {b}_{3} & {b}_{3} \\ {φ}_{l} {b}_{0} & - {φ}_{l} {b}_{0} & {φ}_{l} {b}_{1} & - {φ}_{l} {b}_{1} & {b}_{2} & - {b}_{2} & {b}_{3} & - {b}_{3}\end{matrix} ] ,$$
where,
each of {b₀}, {b₀, b₁}, {b₀, b₁, b₂} and {b₀, b₁, b₂, b₃} is the one 4Tx precoding matrix,
each pair of {b_{0,0}, b_{0,1}} and {b_{1,0}, b_{1,1}, b_{1,2}}, {b_{0,0}, b_{0,1}, b_{0,2}} and {b_{1,0}, b_{1,1}, b_{1,2}}, {b_{0,0}, b_{0,1}, b_{0,2}} and {b_{1,0}, b_{1,1}, b_{1,2}, b_{1,3}}, and {b_{0,0}, b_{0,1}, b_{0,2}, b_{0,3}} and {b_{1,0}, b_{1,1}, b_{1,2}, b_{1,3}} is the two 4Tx precoding matrices,
φₗ is the co-phasing coefficient, and
M indicates a number of antennas in horizontal, and N indicates a number of antennas in vertical.

15. The base unit of claim 9, wherein the TPMI field further indicates a rank of the scheduled PUSCH transmission.

16. A method performed by a base unit, the method comprising:
transmitting a downlink control information (DCI) scheduling a physical uplink shared channel (PUSCH) transmission with 8 antenna ports, wherein the DCI includes a transmit precoding matrix indicator (TPMI) field indicating at least one 4 Tx precoding matrix or two 4Tx precoding matrices and a co-phasing coefficient; and
determining a precoding matrix for the scheduled PUSCH transmission according to the TPMI field.

17. The method of claim 8, wherein:
if the scheduled PUSCH transmission is a rank 1 PUSCH transmission, the co-phasing coefficient is indicated as 1, j, −1 or −j, and
if the scheduled PUSCH transmission is a rank 2 PUSCH transmission, a rank 3 PUSCH transmission, a rank 4 PUSCH transmission, a rank 5 PUSCH transmission, a rank 6 PUSCH transmission, a rank 7 PUSCH transmission, or a rank 8 PUSCH transmission, the co-phasing coefficient is indicated as 1 or j.

18. The method of claim 8, wherein:
if the scheduled PUSCH transmission is a rank 1 PUSCH transmission, the one 4Tx precoding matrix is a rank 1 4Tx precoding matrix;
if the scheduled PUSCH transmission is a rank 2 PUSCH transmission, the one 4Tx precoding matrix is a rank 2 4Tx precoding matrix;
if the scheduled PUSCH transmission is a rank 3 PUSCH transmission, the one 4Tx precoding matrix is a rank 3 4Tx precoding matrix;
2 if the scheduled PUSCH transmission is a rank 4 PUSCH transmission, the one 4Tx precoding matrix is a rank 4 4Tx precoding matrix;
4 if the scheduled PUSCH transmission is a rank 5 PUSCH transmission, the one 4Tx precoding matrix is a rank 3 4Tx precoding matrix, or the two 4Tx precoding matrices are a rank 2 4Tx precoding matrix and a rank 3 4Tx precoding matrix;
if the scheduled PUSCH transmission is a rank 6 PUSCH transmission, the one 4Tx precoding matrix is a rank 3 4Tx precoding matrix, or the two 4Tx precoding matrices are two rank 3 4Tx precoding matrices;
if the scheduled PUSCH transmission is a rank 7 PUSCH transmission, the one 4Tx precoding matrix is a rank 4 4Tx precoding matrix, or the two 4Tx precoding matrices are a rank 3 4Tx precoding matrix and a rank 4 4Tx precoding matrix; and
if the scheduled PUSCH transmission is a rank 8 PUSCH transmission, the one 4Tx precoding matrix is a rank 4 4Tx precoding matrix, or the two 4Tx precoding matrices are two rank 4 4Tx precoding matrices.

19. The method of claim 8, wherein:
if a maximum number of PUSCH layers of the scheduled PUSCH transmission is less than or equal to 4, a length of a part of the TPMI field for indicating the one 4Tx precoding matrix is 4 bits for fully coherent only transmission, and is 5 bits for fully and partial and non-coherent transmission; and
if the maximum number of PUSCH layers of the scheduled PUSCH transmission is larger than 4, the length of the part of the TPMI field for indicating the one 4Tx precoding matrix is 2 bits or 4 bits for fully coherent only transmission and is 3 bits for fully and partial and non-coherent transmission, or a length of a part of the TPMI field for indicating the two 4Tx precoding matrices is 3+2 bits or 4+4 bits for fully coherent only transmission and is 5+3 bits for fully and partial and non-coherent transmission.

20. The method of claim 8, further comprising reporting a maxRank=8.
